(19) United States
(12) Patent Application Publication
(10) Pub. No.: US 2025/0018329 A1
(43) Pub. Date: Jan. 16, 2025

(54) METHOD FOR CAPTURING CARBON DIOXIDE AND GAS ABSORPTION SYSTEM

(71) Applicant: XECA TURBO TECHNOLOGIES (BEIJING) CO., LTD., Beijing (CN)

(72) Inventors: Xijia LV, Beijing (CN); Tu ZHAO, Beijing (CN); Shuxian ZHUANG, Beijing (CN); Yakui BAI, Beijing (CN); Yifan LIU, Beijing (CN); Shen CHEN, Beijing (CN); Di FU, Beijing (CN); Hao ZHANG, Beijing (CN); Junwei ZHANG, Beijing (CN)

(73) Assignee: XECA TURBO TECHNOLOGIES (BEIJING) CO., LTD., Beijing (CN)

(21) Appl. No.: 18/900,845

(22) Filed: Sep. 29, 2024

Related U.S. Application Data
(63) Continuation of application No. PCT/CN2022/126781, filed on Oct. 21, 2022.

(30) Foreign Application Priority Data
Jul. 18, 2022 (CN) 202210843497.8
Jul. 18, 2022 (CN) 202210843553.8
Sep. 27, 2022 (CN) 202211182959.2

(51) Int. Cl. B01D 53/14; B01D 53/62; B01D 53/78; G01N 31/16

(52) U.S. Cl. CPC B01D 53/1475; B01D 53/62; B01D 53/78; G01N 31/164; B01D 2252/10; B01D 2257/504

(57) ABSTRACT

A method for capturing carbon dioxide includes: spraying an alkaline solution through a first spray structure; temporarily storing a solution, in a first temporary storage structure, and making the solution flow out through the first spray structure; detecting a concentration of hydroxide and/or a concentration of carbonate of the solution, and supplementing one of an alkaline solution and water into the first temporary storage structure according to the concentration of the hydroxide and/or the concentration of the carbonate; and in a case that the concentration of the hydroxide is less than or equal to m and the concentration of the carbonate is n, controlling a first pump body or a third pump body to stop running, so that the solution enters an electrolysis device for an electrolysis. Adopting the present disclosure solves problems in that capture efficiency of carbon dioxide gas and overall energy consumption are relatively difficult to control.

### CROSS-REFERENCE TO RELATED APPLICATIONS

This application is a continuation of International Application No. PCT/CN2022/126781, filed on Oct. 21, 2022, which claims priority to Chinese Patent Application No. 202210843553.8, filed on Jul. 18, 2022, Chinese Patent Application No. 202210843497.8, filed on Jul. 18, 2022, and Chinese Patent Application No. 202211182959.2, filed on Sep. 27, 2022. The disclosures of the aforementioned applications are hereby incorporated by reference in their entireties.

### TECHNICAL FIELD

The present disclosure relates to the field of carbon dioxide capture technologies, and in particular, to a method for capturing carbon dioxide and a gas absorption system.

### BACKGROUND

At present, various carbon capture technologies at home and abroad are emerging in an endless stream, however, it is relatively difficult to control capture efficiency of carbon dioxide gas and overall energy consumption of a system for capturing carbon dioxide gas in the related technologies.

### SUMMARY

The main purposes of the present disclosure are to provide a method for capturing carbon dioxide and a gas absorption system, to solve problems in that capture efficiency of carbon dioxide gas and overall energy consumption of a system for capturing carbon dioxide gas are relatively difficult to control in the related technologies.

To achieve the above purposes, according to an aspect of the present disclosure, a method for capturing carbon dioxide is provided, including: spraying an alkaline solution through a first spray structure, so that the alkaline solution flowing out through the first spray structure chemically reacts with carbon dioxide gas in gas to absorb the carbon dioxide gas; temporarily storing a solution, obtained after the alkaline solution chemically reacts with the carbon dioxide gas, in a first temporary storage structure, and making the solution stored temporarily in the first temporary storage structure flow out through the first spray structure; detecting at least one of a concentration of hydroxide and a concentration of carbonate of the solution in the first temporary storage structure in real time, and supplementing one of an alkaline solution and water into the first temporary storage structure according to the at least one of the concentration of the hydroxide and the concentration of the carbonate; and during a process of detecting the at least one of the concentration of the hydroxide and the concentration of the carbonate of the solution in the first temporary storage structure in real time, in a case that the concentration of the hydroxide is detected to be less than or equal to m and the concentration of the carbonate is detected to be n, controlling a first pump body or a third pump body to stop running, so that the solution stored temporarily in the first temporary storage structure enters an electrolysis device for an electrolysis.

Further, a method for making the solution stored temporarily in the first temporary storage structure flow out through the first spray structure includes: starting the first pump body or the third pump body, to pump the solution stored temporarily in the first temporary storage structure into the first spray structure via a pipeline through the first pump body or the third pump body.

Further, a method for supplementing one of an alkaline solution and water into the first temporary storage structure according to the at least one of the concentration of the hydroxide and the concentration of the carbonate includes: in a case that the concentration of the hydroxide is detected to be less than m and the concentration of the carbonate is detected to be less than n, supplementing the alkaline solution into the first temporary storage structure; and in a case that the concentration of the hydroxide is detected to be less than or equal to m and the concentration of the carbonate is detected to be greater than n, supplementing the water into the first temporary storage structure.

Further, a method for detecting a concentration of hydroxide of the solution in the first temporary storage structure in real time includes: feeding the solution into a potentiometric titrator, dripping a standard acid with calibrated H+ concentration into the solution, and during a process of titration, continuously stirring the solution added with the standard acid and recording a first-order differential curve of solution potential with respect to a volume of the standard acid added into the solution, until the first-order differential curve of the solution potential reaches a first peak value, and calculating the concentration of the hydroxide of the solution by using the volume of the standard acid consumed at this time.

Further, a method for detecting a concentration of carbonate of the solution in the first temporary storage structure in real time includes: feeding the solution into a potentiometric titrator, dripping a standard acid with calibrated H+ concentration into the solution, and during a process of titration, continuously stirring the solution added with the standard acid and recording a first-order differential curve of solution potential with respect to a volume of the standard acid added into the solution, until the first-order differential curve of the solution potential reaches a first peak value, recording the volume of the standard acid consumed at this time as V1; continuing to drip the standard acid with the calibrated H+ concentration into the solution, and during a process of the titration, continuing to stir the solution added with the standard acid and recording a first-order differential curve of solution potential with respect to a volume of the standard acid added into the solution, until the first-order differential curve of the solution potential reaches a second peak value, recording the volume of the standard acid consumed at this time as V2; and calculating the concentration of the carbonate of the solution by using a difference between V2 and V1.

Further, a value of m is greater than or equal to 0.1 mol/L and less than or equal to 5 mol/L; and/or a value of n is greater than or equal to 1 mol/L and less than or equal to 6 mol/L.

Further, a value of m is greater than or equal to 0.3 mol/L and less than or equal to 2 mol/L; and/or a value of n is greater than or equal to 2 mol/L and less than or equal to 5.5 mol/L.

Further, during a process where the solution stored temporarily in the first temporary storage structure enters the electrolysis device for the electrolysis, the method for capturing the carbon dioxide further includes: regulating electric charge applied to the electrolysis device, to control a molar yield ratio of carbon dioxide gas to hydrogen in the electrolysis device over unit time and/or a yield of carbon dioxide gas and hydrogen in the electrolysis device over unit time.

Further, a method for regulating electric charge applied to the electrolysis device includes: obtaining a preset value Q of the electric charge applied to the electrolysis device in a case that the molar yield ratio of the carbon dioxide gas to the hydrogen is 1, and increasing nQ on a basis of the preset value Q of the electric charge, to adjust the molar yield ratio of the carbon dioxide gas to the hydrogen, where n is equal to 1, 2, 3, . . . , N(N≤n).

Further, during a process for regulating a molar yield ratio of carbon dioxide gas to hydrogen, the method for capturing the carbon dioxide further includes: detecting a content of an electrolyte in the electrolysis device in real time, and in a case that the content of the electrolyte is less than a preset value, adding an electrolyte to the electrolysis device; and the electrolyte is one of alkali metal sulfate, alkali metal nitrate and alkali metal phosphate.

Further, a method for temporarily storing a solution, obtained after the alkaline solution chemically reacts with the carbon dioxide gas, in a first temporary storage structure includes: providing at least two first temporary storage structures for switching operation, and selectively and temporarily storing the solution, obtained after the alkaline solution chemically reacts with the carbon dioxide gas, in each of the at least two first temporary storage structures; and in a case that a concentration of carbonate in one first temporary storage structure reaches a preset concentration value, deactivating the one temporary storage structure, and enabling a remaining temporary storage structure.

According to another aspect of the present disclosure, a gas absorption system is provided, the gas absorption system is configured to absorb carbon dioxide gas in environment and uses the above method for capturing the carbon dioxide. The gas absorption system includes: a housing provided with an intake port and an exhaust port, the intake port being in communication with the exhaust port, where the exhaust port is located above the intake port; or in a horizontal direction, the intake port and the exhaust port are disposed opposite to each other; a gas pretreatment device disposed inside the housing and located at the intake port for filtering impurities in gas entering the intake port; and a gas absorption assembly disposed inside the housing and located downstream of the gas pretreatment device, the gas absorption assembly including a first liquid supply device and a first spray structure, the first liquid supply device being in communication with the first spray structure to provide an alkaline solution, and the alkaline solution flowing out through the first spray structure chemically reacting with carbon dioxide gas in the gas to absorb the carbon dioxide gas.

Further, the gas absorption assembly further includes: a first filler disposed opposite to the exhaust port, the first filler being located below the first spray structure; and a first water collector located above the first spray structure.

Further, the gas absorption assembly further includes: a first temporary storage structure located below the first filler for temporarily storing a solution obtained after the alkaline solution chemically reacts with the carbon dioxide gas; a first pipeline, an end of the first pipeline being in communication with the first temporary storage structure, and another end of the first pipeline being in communication with the first spray structure; and a first pump body disposed on the first pipeline for pumping the solution entering the first temporary storage structure into the first spray structure.

Further, the gas pretreatment device includes: a second filler disposed opposite to the intake port; a second liquid supply device; and a second spray structure located above the second filler, the second liquid supply device being in communication with the second spray structure.

Further, the gas pretreatment device further includes: a second water collector disposed opposite to the second filler, where there is one second water collector; or there are a plurality of second water collectors, at least one of the plurality of second water collectors is located at a first side of the second filler, and at least one another of the plurality of second water collectors is located at a second side of the second filler.

Further, the gas pretreatment device further includes: a second temporary storage structure located below the second filler for temporarily storing liquid flowing out through the second filler; a second pipeline, an end of the second pipeline being in communication with the second spray structure, and another end of the second pipeline being in communication with the second temporary storage structure; and a second pump body disposed on the second pipeline for pumping the liquid entering the second temporary storage structure into the second spray structure.

Further, the second temporary storage structure includes: a first temporary storage body; a first baffle plate disposed inside the first temporary storage body for dividing an inner cavity of the first temporary storage body into a first sub-accommodating cavity and a second sub-accommodating cavity, the first sub-accommodating chamber being located below the second filler, and the second sub-accommodating cavity being in communication with the second pipeline, where the first baffle plate is provided with an overflow hole, and the first sub-accommodating cavity is in communication with the second sub-accommodating cavity through the overflow hole; or an overflow portion is disposed between the first baffle plate and the first temporary storage body, and the first sub-accommodating cavity is in communication with the second sub-accommodating cavity through the overflow portion.

Further, the second filler includes a plurality of first sub-filler sheets, adjacent two first sub-filler sheets are disposed in a staggered manner and form a flow passage, a surface of each of the plurality of first sub-filler sheets is provided with an interference flow convex portion or an interference flow concave portion located in the flow passage.

Further, the gas absorption system further includes a filter screen or a filter membrane located between the gas pretreatment device and the intake port.

Further, the housing is provided with an accommodating cavity, the intake port is in communication with the exhaust port through the accommodating cavity, and the gas absorption assembly is located inside the accommodation cavity, where there is one intake port, and there is one gas pretreatment device; or there are a plurality of intake ports, the plurality of intake ports are disposed around the accommodating cavity, there are a plurality of gas pretreatment devices, and the plurality of gas pretreatment devices and the plurality of intake ports are in a one-to-one correspondence.

Further, the gas absorption system further includes: a gas delivery device disposed at at least one of the exhaust port and the intake port; and a first detection device disposed inside the first temporary storage structure for detecting a concentration of carbonate of a solution; and in a case that a detection value of the first detection device reaches a first preset concentration value, the gas delivery device is controlled to stop running.

Further, the gas delivery device includes: a fan disposed at the exhaust port; and/or a compressor disposed at the intake port.

Further, the gas absorption system further includes: a second detection device disposed inside the first temporary storage structure for detecting a concentration of hydroxide of a solution; and in a case that a detection value of the second detection device is less than a second preset concentration value, the first pump body is controlled to start.

Further, a bottom surface of the first temporary storage structure is provided with a flow guidance slope.

Further, the gas absorption system further includes: a hydroturbine located below the first temporary storage structure, liquid inside the first temporary storage structure flowing to the hydroturbine through the flow guidance slope; and a generator connected to the hydroturbine.

Further, the gas absorption system further includes: a stirring device disposed inside the first temporary storage structure.

Further, the gas absorption system further includes: a gas delivery device disposed at at least one of the exhaust port and the intake port.

Further, the gas delivery device includes: a fan disposed at the exhaust port; and/or a compressor disposed at the intake port.

Further, the gas absorption assembly includes: a third filler located below the first spray structure; and a third water collector disposed opposite to the third filler, where the third water collector is located between the exhaust port and the third filler; and/or the third water collector is located between the third filler and the gas pretreatment device.

Further, the gas absorption assembly further includes: a third temporary storage structure located below the third filler for temporarily storing a solution obtained after the alkaline solution chemically reacts with the carbon dioxide gas, where there is one third temporary storage structure; or there are a plurality of third temporary storage structures, and the plurality of third temporary storage structures are selectively put into use.

Further, there are a plurality of third temporary storage structures, and the gas absorption assembly further includes: a second main pipeline, a first end of the second main pipeline being in communication with the first spray structure; a plurality of third branch pipelines, the plurality of third branch pipelines and the plurality of third temporary storage structures being in a one-to-one correspondence, an end of each of the plurality of third branch pipelines being in communication with respective third temporary storage structures, and another end of each of the plurality of third branch pipelines being in communication with a second end of the second main pipeline; and a plurality of second control valves, the plurality of second control valves and the plurality of third branch pipelines being in a one-to-one correspondence, and each of the plurality of second control valves being configured to control an on-off state of respective third branch pipelines; and at any time, at least one of the plurality of second control valves is in an open state.

Further, the gas absorption assembly further includes: a third detection device disposed on the second main pipeline for detecting a concentration of carbonate of a solution in the second main pipeline; and in a case that a detection value of the third detection device reaches a preset concentration value, a third branch pipeline corresponding to a third temporary storage structure that has been put into use is controlled to be in a disconnected state by at least one second control valve, and at least one another third temporary storage structure is controlled to put into use by at least one another second control valve.

Further, the gas absorption assembly further includes: a third pump body disposed on one of the second main pipeline and the third branch pipeline for pumping the solution entering the third temporary storage structure into the first spray structure.

Further, the gas pretreatment device includes: a fourth filler disposed opposite to the intake port; a third liquid supply device; a third spray structure located above the fourth filler, the third liquid supply device being in communication with the third spray structure; and a fourth water collector disposed opposite to the fourth filler.

Further, there is one fourth water collector; or there are a plurality of fourth water collectors, at least one of the plurality of fourth water collectors is located at a first side of the fourth filler, and at least one another of the plurality of fourth water collectors is located at a second side of the fourth filler.

Further, the gas pretreatment device further includes: a fourth temporary storage structure located below the fourth filler for temporarily storing liquid flowing out through the fourth filler; a third main pipeline, an end of the third main pipeline being in communication with the third spray structure, and another end of the third main pipeline being in communication with the fourth temporary storage structure; and a fourth pump body disposed on the third main pipeline for pumping the liquid entering the fourth temporary storage structure into the third spray structure.

Further, the four temporary storage structure includes: a second temporary storage body; a second baffle plate disposed inside the second temporary storage body to divide an inner cavity of the second temporary storage body into a third sub-accommodating cavity and a fourth sub-accommodating cavity, the third sub-accommodating cavity being located below the fourth filler, and the fourth sub-accommodating cavity being in communication with the third main pipeline, where the second baffle plate is provided with an overflow hole, and the third sub-accommodating cavity is in communication with the fourth sub-accommodating cavity through the overflow hole; or an overflow portion is disposed between the second baffle plate and the second temporary storage body, and the third sub-accommodating cavity is in communication with the fourth sub-accommodating cavity through the overflow portion.

Further, the fourth filler includes a plurality of second sub-filler sheets, adjacent two second sub-filler sheets are disposed in a staggered manner and form a flow passage, a surface of each of the plurality of second sub-filler sheets is provided with an interference flow convex portion or an interference flow concave portion located in the flow passage.

Further, the gas absorption system further includes an electrolysis device, the electrolysis device is located downstream of the first temporary storage structure, and a carbonic acid solution discharged through the first temporary storage structure is electrolyzed by the electrolysis device, so that potassium hydroxide and hydrogen are generated at a cathode of the electrolysis device, and gas obtained by mixing oxygen and carbon dioxide is generated at an anode of the electrolysis device; and the potassium hydroxide is used for absorbing carbon dioxide of the gas absorption system.

The technical solutions of the present disclosure are applied, the alkaline solution is sprayed through the first spray structure, so that the alkaline solution flowing out through the first spray structure chemically reacts with the carbon dioxide gas in the gas to absorb the carbon dioxide gas. During the above processes, the solution, obtained after the alkaline solution chemically reacts with the carbon dioxide gas, is temporarily stored in the first temporary storage structure, and the solution stored temporarily in the first temporary storage structure flows out again through the first spray structure, so as to achieve recycling of the solution. During a process of capturing carbon dioxide gas, the at least one of the concentration of the hydroxide and the concentration of the carbonate of the solution in the first temporary storage structure is detected in real time, and one of the alkaline solution and the water is supplemented into the first temporary storage structure according to the at least one of the concentration of the hydroxide and the concentration of the carbonate. The concentration of the hydroxide and the concentration of the carbonate of the solution in a final state are precisely controlled by means of alkaline solution supplement or water addition, so as to meet requirements of a process of a subsequent electrolysis, thereby reducing energy consumption of an overall system, and further solving the problems in that capture efficiency of carbon dioxide gas and overall energy consumption of a system for capturing carbon dioxide are relatively difficult to control in the related technologies, and thus improving capture efficiency of a system for capturing carbon dioxide. During the process of detecting the at least one of the concentration of the hydroxide and the concentration of the carbonate of the solution in the first temporary storage structure in real time, in the case that the concentration of the hydroxide is detected to be less than or equal to m and the concentration of the carbonate is detected to be n, the first pump body or the third pump body is controlled to stop running, so that the solution stored temporarily in the first temporary storage structure enters the electrolysis device for the electrolysis.

### BRIEF DESCRIPTION OF THE DRAWINGS

The accompanying drawings, attached to the specification and forming a part of the present disclosure, are configured to provide a further understanding of the present disclosure, and schematic embodiments of the present disclosure and the description thereof are configured to explain the present disclosure and do not constitute an improper limitation on the present disclosure. In the accompanying drawings:

FIG. 1 is a flowchart of a method for capturing carbon dioxide according to an embodiment of the present disclosure;

FIG. 2 is a flowchart of a treatment method for hydroxide and carbonate with different concentrations of a solution in a temporary storage structure in the method for capturing the carbon dioxide in FIG. 1;

FIG. 3 is a main view of a gas absorption system according to an embodiment of the present disclosure;

FIG. 4 is a top view of the gas absorption system in FIG. 3;

FIG. 5 is a side view of the gas absorption system in FIG. 3;

FIG. 6 is a main view of a gas absorption system according to an embodiment of the present disclosure; and

FIG. 7 is a top view of the gas absorption system in FIG. 6.

### DETAILED DESCRIPTION OF THE EMBODIMENTS

It should be noted that the embodiments in the present disclosure or features in the embodiments may be combined with each other without conflict. The present disclosure is described in detail below with reference to the accompanying drawings and in conjunction with the embodiments.

It should be pointed out that, unless otherwise specified, all technical terms and scientific terms used in the present disclosure have the same meanings as those commonly understood by ordinary technicians in the technical field to which the present disclosure belongs.

In the present disclosure, unless otherwise stated, directional words such as “above” and “below” are usually referred to the directions shown in the accompanying drawings, or the vertical direction, the perpendicular direction or the gravitational direction; similarly, for ease of understanding and description, directional words “left” and “right” are usually referred to the left and right shown in the accompanying drawings; and directional words “inside” and “outside” are referred to inner and outer contours of each component itself. However, the above directional words are not intended to limit the present disclosure.

At present, the mainstream methods for capturing carbon dioxide (CO₂) at home and abroad mainly include a liquid amine adsorption method, a solid membrane adsorption method and the like. However, in the above methods, only CO₂ with a high concentration can be captured, and CO₂ with a wide concentration range cannot be captured, for example, CO₂ with a low concentration in air cannot be captured.

In the related technologies, in order to solve the above problems, a method with an inorganic alkali such as potassium hydroxide as a liquid absorbent is adopted to capture carbon sources with a wide concentration range such as air and flue gas, an inorganic alkaline solution obtained after the capturing is converted into a carbonate solution, and an alkaline solution may be regenerated by using a method of an electrolysis.

However, during a process of an electrolysis, a concentration of carbonate is too high or too low, which results in an increase of a voltage of an electrolytic cell, thereby increasing energy consumption of a system. As for a remaining inorganic alkali, if a concentration of a remaining alkaline solution is too high, it is necessary to first consume all hydroxide in the inorganic alkali before carbonate is electrolyzed, which causes a significant power consumption; and if the concentration of the remaining alkaline solution is too low, capture efficiency of carbon dioxide gas during a capture process cannot be effectively ensured. Therefore, it is relatively difficult to control capture efficiency of carbon dioxide gas and overall energy consumption of a system for capturing carbon dioxide gas in the related technologies.

In order to solve problems in that capture efficiency of carbon dioxide gas and overall energy consumption of a system for capturing carbon dioxide gas are relatively difficult to control in the related technologies, the present disclosure provides a method for capturing carbon dioxide and a gas absorption system.

### Embodiment 1

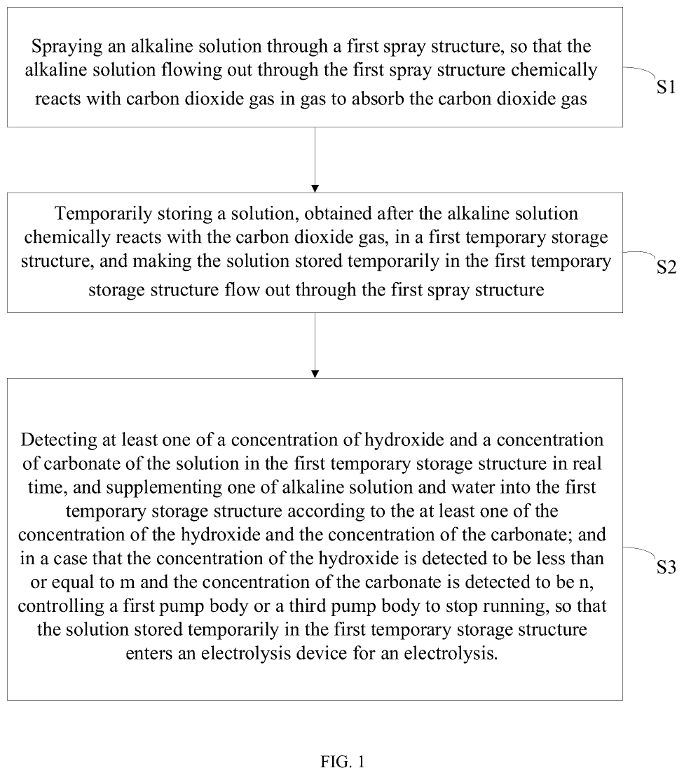

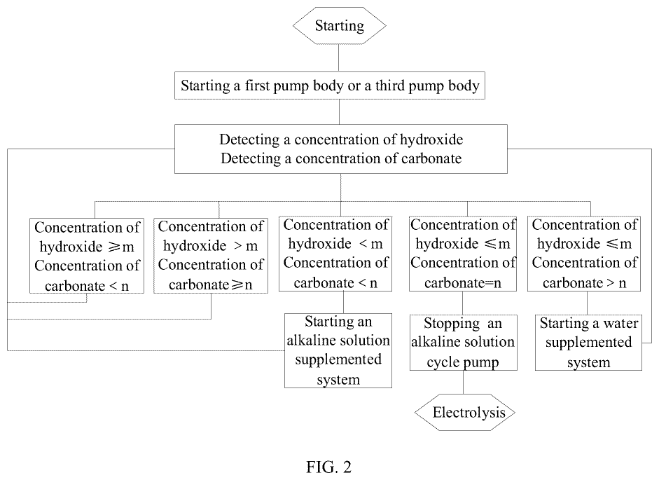

As shown in FIG. 1 and FIG. 2, a method for capturing carbon dioxide includes:
S1, spraying an alkaline solution through a first spray structure, so that the alkaline solution flowing out through the first spray structure chemically reacts with carbon dioxide gas in gas to absorb the carbon dioxide gas;
S2, temporarily storing a solution, obtained after the alkaline solution chemically reacts with the carbon dioxide gas, in a first temporary storage structure, and making the solution stored temporarily in the first temporary storage structure flow out through the first spray structure; and
S3, detecting at least one of a concentration of hydroxide and a concentration of carbonate of the solution in the first temporary storage structure in real time, and supplementing one of an alkaline solution and water into the first temporary storage structure according to the at least one of the concentration of the hydroxide and the concentration of the carbonate; and in a case that the concentration of the hydroxide is detected to be less than or equal to m and the concentration of the carbonate is detected to be n, controlling a first pump body or a third pump body to stop running, so that the solution stored temporarily in the first temporary storage structure enters an electrolysis device for an electrolysis.

The technical solutions of this embodiment are applied, the alkaline solution is sprayed through the first spray structure, so that the alkaline solution flowing out through the first spray structure chemically reacts with the carbon dioxide gas in the gas to absorb the carbon dioxide gas. During the above processes, the solution, obtained after the alkaline solution chemically reacts with the carbon dioxide gas, is temporarily stored in the first temporary storage structure, and the solution stored temporarily in the first temporary storage structure flows out again through the first spray structure, so as to achieve recycling of the solution. During a process of capturing carbon dioxide gas, the at least one of the concentration of the hydroxide and the concentration of the carbonate of the solution in the first temporary storage structure is detected in real time, and one of the alkaline solution and the water is supplemented into the first temporary storage structure according to at least one of the concentration of the hydroxide and the concentration of the carbonate. The concentration of the hydroxide and the concentration of the carbonate of the solution in a final state are precisely controlled by means of alkaline solution supplement or water addition, so as to meet requirements of a process of a subsequent electrolysis, thereby reducing energy consumption of an overall system, and further solving the problems in that capture efficiency of carbon dioxide gas and overall energy consumption of a system for capturing carbon dioxide are relatively difficult to control in the related technologies, and thus improving capture efficiency of a system for capturing carbon dioxide. During the process of detecting the at least one of the concentration of the hydroxide and the concentration of the carbonate of the solution in the first temporary storage structure in real time, in the case that the concentration of the hydroxide is detected to be less than or equal to m and the concentration of the carbonate is detected to be n, the first pump body or the third pump body is controlled to stop running, so that the solution stored temporarily in the first temporary storage structure enters the electrolysis device for the electrolysis.

In this embodiment, a method for making the solution stored temporarily in the first temporary storage structure flow out through the first spray structure includes:
starting the first pump body or the third pump body, to pump the solution stored temporarily in the first temporary storage structure into the first spray structure via a pipeline through the first pump body or the third pump body.

Specifically, during a process of capturing carbon dioxide gas by a system for capturing carbon dioxide, the solution stored temporarily in the first temporary storage structure is pumped into the first spray structure via the pipeline through the first pump body or the third pump body, so as to reuse the above solution, thereby achieving the recycling of the solution, and thus avoiding waste of resource. The solution is pumped into the first spray structure through the first pump body or the third pump body, so as to ensure that the alkaline solution can be sprayed through the first spray structure to react with CO₂, thereby improving spray reliability of the first spray structure, and thus improving operational reliability of a system for capturing carbon dioxide.

In this embodiment, a method for supplementing one of an alkaline solution and water into the first temporary storage structure according to the at least one of the concentration of the hydroxide and the concentration of the carbonate includes:
in a case that the concentration of the hydroxide is detected to be less than m and the concentration of the carbonate is detected to be less than n, supplementing the alkaline solution into the first temporary storage structure; and
in a case that the concentration of the hydroxide is detected to be less than or equal to m and the concentration of the carbonate is detected to be greater than n, supplementing the water into the first temporary storage structure.

Specifically, an initial alkaline solution is placed in the first temporary storage structure located at a bottom of a system for capturing carbon dioxide, the first pump body or the third pump body starts to capture the carbon dioxide gas, and the concentration of the hydroxide and the concentration of the carbonate are detected in real time. In the case that the concentration of the hydroxide of the solution in the first temporary storage structure is greater than or equal to m and the concentration of the carbonate of the solution in the first temporary storage structure is less than n, or in the case that the concentration of the hydroxide of the solution in the first temporary storage structure is greater than m and the concentration of the carbonate of the solution in the first temporary storage structure is greater than or equal to n, the first pump body or the third pump body operates continuously, and no related measures are taken; in the case that the concentration of the hydroxide of the solution in the first temporary storage structure is less than m and the concentration of the carbonate of the solution in the first temporary storage structure is less than n, an alkaline solution supplemented device starts and the alkaline solution is supplemented into the first temporary storage structure, and the concentration of the hydroxide and the concentration of the carbonate in the first temporary storage structure continue to be detected; and in the case that the concentration of the hydroxide of the solution in the first temporary storage structure is less than or equal to m and the concentration of the carbonate of the solution in the first temporary storage structure is greater than n, a water supplemented system starts and the water is supplemented into the first temporary storage structure, and the concentration of the hydroxide and the concentration of the carbonate in the first temporary storage structure continue to be detected.

Optionally, a method for detecting a concentration of hydroxide of the solution in the first temporary storage structure in real time includes:

feeding the solution into a potentiometric titrator, dripping a standard acid with calibrated H+ concentration into the solution, and during a process of titration, continuously stirring the solution added with the standard acid and recording a first-order differential curve of solution potential with respect to a volume of the standard acid added into the solution, until the first-order differential curve of the solution potential reaches a first peak value, and calculating the concentration of the hydroxide of the solution by using the volume of the standard acid consumed at this time.

In this embodiment, a calibrated HCl solution with an actual concentration of 0.2404 mol/L is used as a titrant, and the calibrated HCl solution is slowly dripped into the solution, until a pH value of the solution is below 2, changes in an added volume of the standard acid and a pH value of the solution are recorded, and the recorded added volume of the standard acid and the recorded pH value are plotted as a pH-V curve, a first-order numerical differential curve of A pH/ΔV-V is calculated and then is plotted according to the recorded curve, a maximum value of the above first-order numerical differentiation is taken as an equivalence point, a titration volume at the equivalence point is obtained through the first-order numerical differentiation, the corresponding equivalence point is the EPI shown in a pH-V change chart of the volume of the standard acid, and the concentration of the OH⁻ of the solution is calculated by using the volume at the equivalence point and a concentration at the equivalence point. The titration takes about 10 minutes from start to finish.

In other embodiments not shown in the accompanying drawings, determination of alkalinity of a solution in neutral leaching is adopted, a HCl solution with calibrated concentration is used, the HCl solution with a calibrated H+ concentration of 0.1107 mol/L is used as a titrant, and the HCl solution is slowly dripped into the solution, until a pH value of the solution is about 3, changes in a consumption volume of the standard acid and a pH value of the solution are recorded, and the recorded titration volume and the recorded pH value are plotted as a pH-V curve, a first-order numerical differential curve of ΔpH/ΔV-V is calculated and then is plotted according to the recorded curve, the volume of the standard acid corresponding to a maximum value of the above first-order numerical differentiation is taken as an equivalence point, a titration volume at the equivalence point is obtained through the first-order numerical differentiation, a pH value at the corresponding equivalence point is 5.02, and the concentration of the OH of the solution is calculated by using the volume at the equivalence point and a concentration at the equivalence point. The titration takes about 10 minutes from start to finish.

In other embodiments not shown in the accompanying drawings, determination of alkalinity after a post-liquid acidification process is adopted, a calibrated HCl solution with an actual concentration of 0.1107 mol/L is used as a titrant, and the calibrated HCl solution is slowly dripped into the solution, until the pH value of the solution is about 3.8, changes in a consumption volume of the standard acid and a pH value of the solution are recorded, and the recorded titration volume and the recorded pH value are plotted as a pH-V curve, a first-order numerical differential curve of ΔpH/ΔV-V is calculated and then is plotted according to the recorded curve, the volume of the standard acid corresponding to a maximum value of the above first-order numerical differentiation is taken as an equivalence point, a titration volume at the equivalence point is obtained through the first-order numerical differentiation, a pH value at the corresponding equivalence point is 4.42, and the concentration of the OH⁻ of the solution is calculated by using the volume at the equivalence point and a concentration at the equivalence point. The titration takes about 10 minutes from start to finish.

In other embodiments not shown in the accompanying drawings, a standard acid used in calibration experiments is adopted (i.e. a H+ concentration of a prepared hydrochloric acid solution is calibrated by using well-known methods), which is implemented in accordance with the National Standards GB/T601-2003. This method is calibrated twice, for the first calibration, a concentration of a standard alkali is calibrated first, and then a calibrated standard alkali solution with a known concentration is used to calibrate the standard acid. An embodiment of calibrating the alkali solution is to dry potassium hydrogen phthalate primary standard at 105° C. to 110° C. to a constant weight, dissolve 110 g of sodium hydroxide into 100 ml of water without carbon dioxide, place a solution, obtained after 110 g of the sodium hydroxide is dissolved into 100 ml of the water without carbon dioxide, in a closed polyethylene container until the solution is clear, take 10.8 ml of the clear solution at a top, and dilute the clear solution with water to 1000 ml to prepare a sodium hydroxide titrant. The potassium hydrogen phthalate primary standard that has been dried to the constant weight is weighed for 0.1377 g, 0.1377 g of the potassium hydrogen phthalate primary standard is added with water to 50 ml-60 ml, the potassium hydrogen phthalate primary standard added with the water is stirred until the potassium hydrogen phthalate primary standard added with the water is dissolved completely, and titrating and plotting are performed by an automatic potentiometric titrator using the same final judging principle as the above embodiments, so that a titration volume at an equivalence point is obtained through first-order numerical differentiation in the above chart, a pH value at the equivalence point is 8.81, and a concentration of the sodium hydroxide titrant is calculated accordingly. The titration takes about 5 minutes from start to finish. A hydrochloric acid titrant is calibrated by using a titrant with a standard calibrated concentration. 27 ml of hydrochloric acid is diluted with water to 1000 ml to prepare the hydrochloric acid titrant. 3.0000 ml of the hydrochloric acid titrant is added into a beaker and then is added with water to 50 ml to 60 ml, after the hydrochloric acid titrant added with the water is stirred for 90 seconds, the titrating and the plotting are performed by the automatic potentiometric titrator using the same final judging principle as the embodiment 1 to the embodiment 3, so that a titration volume at an equivalence point is obtained through the first-order numerical differentiation in the above chart, a pH value at the equivalence point is 7.45, and a H+ concentration of the hydrochloric acid as the standard acid is calculated by using a concentration of the sodium hydroxide titrant and an adding volume of the hydrochloric acid. The titration takes about 5 minutes from start to finish.

In this embodiment, a method for detecting a concentration of carbonate of the solution in the first temporary storage structure in real time includes:
dripping a standard acid with calibrated H+ concentration into the solution, and during a process of titration, continuously stirring the solution added with the standard acid and recording a first-order differential curve of solution potential with respect to a volume of the standard acid added into the solution, until the first-order differential curve of the solution potential reaches a first peak value, recording the volume of the standard acid consumed at this time as V1; continuing to drip the standard acid with the calibrated H+ concentration into the solution, and during a process of the titration, continuing to stir the solution added with the standard acid and recording a first-order differential curve of the solution potential with respect to a volume of the standard acid added into the solution, until the first-order differential curve of the solution potential reaches a second peak value, recording the volume of the standard acid consumed at this time as V2; and calculating the concentration of the carbonate of the solution by using a difference between V2 and V1.

Optionally, a value of m is greater than or equal to 0.1 mol/L and less than or equal to 5 mol/L; and/or a value of n is greater than or equal to 1 mol/L and less than or equal to 6 mol/L. In this way, the above arrangement makes the value of m and value of n more flexible, so as to meet different usage requirements and working conditions.

Optionally, a value of m is greater than or equal to 0.3 mol/L and less than or equal to 2 mol/L; and/or a value of n is greater than or equal to 2 mol/L and less than or equal to 5.5 mol/L. In this way, the above arrangement makes the value of m and value of n more flexible, so as to meet different usage requirements and working conditions.

In this embodiment, the value of m is 0.1 mol/L and the value of n is 6 mol/L. The alkaline solution is sprayed through the spray structure, so that the alkaline solution flowing out through the spray structure chemically reacts with the carbon dioxide gas in the gas, and during a process for capturing carbon dioxide gas, the concentration of the hydroxide and the concentration of the carbonate of the solution in the first temporary storage structure are detected in real time. In the case that the concentration of the hydroxide of the solution in the first temporary storage structure is greater than or equal to 0.1 mol/L and the concentration of the carbonate of the solution in the first temporary storage structure is less than 6 mol/L, or in the case that the concentration of the hydroxide of the solution in the first temporary storage structure is greater than 0.1 mol/L and the concentration of the carbonate of the solution in the first temporary storage structure is greater than or equal to 6 mol/L, the first pump body or the third pump body operates continuously, and no related measures are taken; in the case that the concentration of the hydroxide of the solution in the first temporary storage structure is less than 0.1 mol/L and the concentration of the carbonate of the solution in the first temporary storage structure is less than 6 mol/L, an alkaline solution supplemented device starts and the alkaline solution is supplemented into the first temporary storage structure, and the concentration of the hydroxide and the concentration of the carbonate in the first temporary storage structure continue to be detected; and in the case that the concentration of the hydroxide of the solution in the first temporary storage structure is less than or equal to 0.1 mol/L and the concentration of the carbonate of the solution in the first temporary storage structure is greater than 6 mol/L, a water supplemented system starts and the water is supplemented into the first temporary storage structure, and the concentration of the hydroxide and the concentration of the carbonate in the first temporary storage structure continue to be detected. In the case that the concentration of the hydroxide is detected to be less than or equal to 0.1 mol/L and the concentration of the carbonate is detected to be 6 mol/L, the first pump body or the third pump body is controlled to stop running, so that the solution stored temporarily in the first temporary storage structure enters the electrolysis device for the electrolysis.

It should be noted that the value of m and the value of n are not limited thereto and may be adjusted according to working conditions and usage requirements.

It should be noted that, the unit kWh/kgCO₂ represents: an amount of electricity (kWh) consumed by an electrolysis device for every 1 kg of CO₂ produced during a process of an electrolysis.

In this embodiment, during a process where the solution stored temporarily in the first temporary storage structure enters the electrolysis device for the electrolysis, the method for capturing the carbon dioxide further includes:

regulating electric charge applied to the electrolysis device, so as to control a molar yield ratio of carbon dioxide gas to hydrogen in the electrolysis device over unit time and/or a yield of carbon dioxide gas and hydrogen in the electrolysis device over unit time.

Specifically, during a process for electrolytic regeneration of alkali, the absorbed carbon dioxide gas is released, while a high-value hydrogen is generated. The carbon dioxide gas and the hydrogen may synthesize a variety of chemicals, which provides a good solving basis for comprehensive utilization of carbon dioxide gas. However, a molar yield ratio of carbon dioxide gas to hydrogen required for synthesizing different chemicals is different, and therefore, how to control an output ratio of carbon dioxide gas and hydrogen during a process for electrolytic regeneration of inorganic alkali is also necessary. An electrolyte component is added to the electrolysis device, so as to enhance conductivity, thereby reducing energy consumption of an electrolysis. Water may also be electrolyzed after carbonate is electrolyzed completely, so as to further generate hydrogen, and therefore, the molar yield ratio of carbon dioxide gas to hydrogen in the electrolysis device over unit time may be controlled by changing the applied electric charge, so that an application scope of a system is greatly improved.

In this embodiment, a method for regulating electric charge applied to the electrolysis device includes:

obtaining a preset value Q of the electric charge applied to the electrolysis device in a case that the molar yield ratio of the carbon dioxide gas to the hydrogen is 1, and increasing nQ on a basis of the preset value Q of the electric charge, to adjust the molar yield ratio of the carbon dioxide gas to the hydrogen, where n is equal to 1, 2, 3, . . . , N(N≤n).

Specifically, taking the processing of a solution containing 1 mol of carbonate over unit time as an example, an electrolyte added to the electrolysis device is potassium sulfate, a concentration of the potassium sulfate at an anode is set to be 0.5 mol/L, and the electric charge applied to the electrolysis device is controlled, so that electric charge obtained by 1 mol of a carbonate solution is 53.6 A·h, and the molar yield ratio of the carbon dioxide gas to the hydrogen is 1:1. On this basis, for every 53.6 A·h of additional applied electric charge, the yield of the carbon dioxide gas is 0, and the yield of the hydrogen increases by 1 mol, i.e., the molar yield ratio of the carbon dioxide gas to the hydrogen over unit time becomes 1:2, so that the molar yield ratio of the carbon dioxide gas to the hydrogen is adjustable. In this embodiment, the electric charge applied to the electrolysis device is controlled, so that the electric charge obtained by 1 mol of the carbonate solution is 54.0 A·h, power consumption of the electrolysis device is measured to be 3.30 kWh/kgCO₂, and the molar yield ratio of the carbon dioxide gas to the hydrogen is 1:1.01.

In this embodiment, during a process for regulating a molar yield ratio of carbon dioxide gas to hydrogen, the method for capturing the carbon dioxide further includes:
detecting a content of an electrolyte in the electrolysis device in real time, and in a case that the content of the electrolyte is less than a preset value, adding an electrolyte to the electrolysis device; and the electrolyte is one of alkali metal sulfate, alkali metal nitrate and alkali metal phosphate.

Optionally, the preset value is 0. Specifically, during the process for regulating the molar yield ratio of the carbon dioxide gas to the hydrogen, in the case that the content of the electrolyte is less than the preset value, the electrolyte is added to the anode of the electrolysis device, and the applied electric charge is changed, so that the molar yield ratio of the carbon dioxide gas to the hydrogen gas in the electrolysis device over unit time is controlled, thereby ensuring capture efficiency of carbon dioxide and greatly reducing overall energy consumption of a system, and thus facilitating controlling capture efficiency of carbon dioxide gas and overall energy consumption of a system for capturing carbon dioxide.

Optionally, the alkali metal sulfate is one of potassium sulfate and sodium sulfate.

Optionally, the alkali metal nitrate is one of potassium nitrate and sodium nitrate.

Optionally, the alkali metal phosphate is one of potassium phosphate and sodium phosphate.

Optionally, the alkaline solution is alkali metal hydroxide.

Optionally, a method for temporarily storing a solution, obtained after the alkaline solution chemically reacts with the carbon dioxide gas, in a first temporary storage structure includes:
providing at least two first temporary storage structures for switching operation, and selectively and temporarily storing the solution, obtained after the alkaline solution chemically reacts with the carbon dioxide gas, in each of the at least two first temporary storage structures; and in a case that a concentration of carbonate in one first temporary storage structure reaches a preset concentration value, deactivating the one temporary storage structure, and enabling a remaining temporary storage structure.

In this embodiment, there are two first temporary storage structures, and in the case that the concentration of the carbonate in a first first temporary storage structure reaches the preset concentration value, a second first temporary storage structure enables, so that carbon dioxide is captured by the alkaline solution in the second first temporary storage structure, a carbonate solution in the first first temporary storage structure is emptied, and then a fresh alkaline solution is supplemented into the first first temporary storage structure again, and after the concentration of the carbonate in the second first temporary storage structure reaches the preset concentration value, the first first temporary storage structure enables again, and these processes are repeated alternately in such a way.

Optionally, the alkali metal hydroxide is one of potassium oxide and sodium hydroxide.

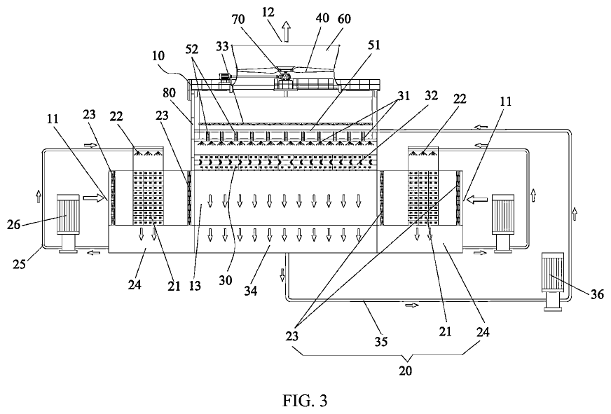

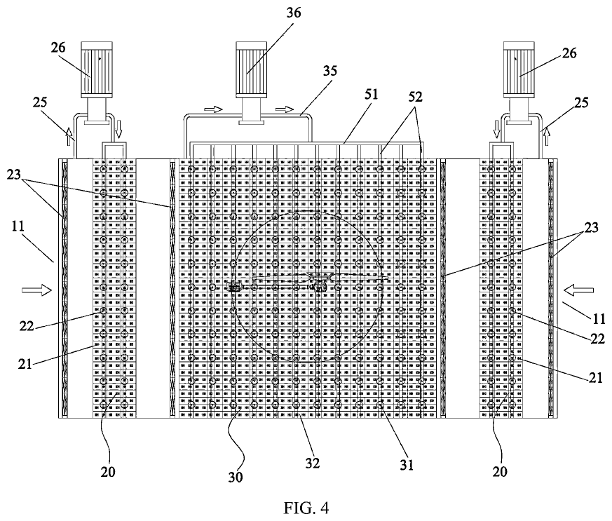

As shown in FIG. 3 to FIG. 5, a gas absorption system is configured to absorb carbon dioxide gas in environment, the gas absorption system includes a housing 10, a gas pretreatment device 20 (for example, a gas dust filtration device or a gas dehydration device) and a gas absorption assembly 30 (for example, an alkaline solution plate tower for capturing carbon dioxide or an alkaline solution packing tower for capturing carbon dioxide). The housing 10 is provided with an intake port 11 and an exhaust port 12, the intake port 11 is in communication with the exhaust port 12, and the exhaust port 12 is located above the intake port 11. The gas pretreatment device 20 is disposed inside the housing 10 and is located at the intake port 11 for filtering impurities in gas entering the intake port 11. The gas absorption assembly 30 is disposed inside the housing 10 and is located downstream of the gas pretreatment device 20, the gas absorption assembly 30 includes a first liquid supply device (for example, a centrifugal pump, a gear pump or a magnetic drive pump) and a first spray structure 31, the first liquid supply device is in communication with the first spray structure 31 to provide an alkaline solution, and the alkaline solution flowing out through the first spray structure 31 chemically reacts with carbon dioxide gas in the gas to absorb the carbon dioxide gas.

The technical solutions of this embodiment are applied, the gas pretreatment device 20 is disposed inside the housing 10 and is located at the intake port 11, and the gas absorption assembly 30 is located downstream of the gas pretreatment device 20. In this way, during an operation of the gas absorption system, after air or flue gas enters the gas absorption system through the intake port 11, the air or the flue gas passes through the gas pretreatment device 20 first, and impurities in the air or the flue gas are filtered by the gas pretreatment device 20, which avoids accumulation of the above impurities in the gas absorption system, and avoids affecting efficiency of absorbing and capturing carbon dioxide gas by the gas absorption system caused by the above impurities entering the gas absorption assembly 30, so as to solve problems in that the impurities such as solid particles mixing in the air or the flue gas are easily accumulated in a system for capturing CO₂ in the related technologies, and thus reducing an operation cost and a maintenance cost of the gas absorption system. Absorbing the impurities in the air or the flue gas can also improve a purity of a solution obtained after the alkaline solution chemically reacts with the carbon dioxide gas, thereby reducing a cost of a post-treatment process.

Optionally, the alkaline solution is one of sodium hydroxide, potassium hydroxide, potassium carbonate and sodium carbonate, and solutions with different concentrations may be prepared with deionized water as needed.

In this embodiment, an alkaline solution is used as an absorbent, which not only can capture CO₂ with a high concentration, but also can capture CO₂ with a low concentration, so as to realize the capturing of CO₂ with a wide concentration range.

In this embodiment, the gas absorption system is a countercurrent absorption system, i.e., an intake direction of the air or the flue gas is perpendicular to an exhaust direction of the air or the flue gas.

In this embodiment, there are a plurality of first spray structures 31, the plurality of first spray structures 31 are disposed at intervals along a flow direction of the gas in the gas absorption system, thereby increasing a quantity of the alkaline solution sprayed out through the first spray structures 31, and thus ensuring that the alkaline solution sprayed out through the first spray structures 31 can fully capture and absorb CO₂ in the air or the flue gas.

Specifically, a side wall of the housing 10 is provided with a staircase 80, and the workers may climb to a top of the housing 10 through the staircase 80 to repair the gas absorption system. Optionally, the first spray structure 31 is a nozzle.

As shown in FIG. 3 to FIG. 5, the gas absorption assembly 30 further includes a first filler 32 and a first water collector 33. The first filler 32 is disposed opposite to the exhaust port 12, and the first filler 32 is located below the first spray structure 31. The first water collector 33 is located above the first spray structure 31. In this way, disposal of the first filler 32 provides sufficient contact surface for the CO₂ and the alkaline solution, so that the CO₂ in the air or the flue gas fully reacts with the alkaline solution, which further improves efficiency of capturing and absorbing CO₂ by the gas absorption assembly 30. The first water collector 33 is configured to recover water vapor in the housing 10 to reduce fine water droplet drift carried in the gas discharged through the exhaust port 12, which can effectively prevent a loss of liquid water caused by a phenomenon of water splashing at the exhaust port 12.

Specifically, the alkaline solution falls in a form of droplets from the first spray structure 31 into the first filler 32, and flows in a form of a liquid film in the first filler 32, and the alkaline solution falls in the form of the droplets into the first temporary storage structure 34 after passing through the first filler 32. The gas enters the gas absorption assembly 30 after the impurities carried in the air or the flue gas are removed through the gas pretreatment device 20, and the pretreated gas is in full contact with the alkaline solution in a water spraying area and the first filler 32 of the gas absorption assembly 30, so that CO₂ in the air or the flue gas chemically reacts with the alkaline solution, thereby capturing the CO₂. The captured CO₂ exists in the first temporary storage structure 34 in a form of carbonate and bicarbonate ions, and the first pump body 36 is configured to deliver the solution obtained after the reacting to a subsequent process system for processing. The first temporary storage structure 34 is provided with a first liquid supply device to supplement water and hydroxide consumed in the solution.

Optionally, the first filler 32 is a thin-film water-spraying filler.

Optionally, the first water collector 33 is a PVC water collector, and the first water collector 33 is supported by a bracket.

As shown in FIG. 3 to FIG. 5, the gas absorption assembly 30 further includes a first temporary storage structure 34 (for example, a stainless steel alkaline solution storage tank or a stainless steel alkaline storage vessel), a first pipeline 35 and a first pump body 36 (for example, a centrifugal pump, a reciprocating pump, a rotary pump or a fluid action pump). The first temporary storage structure 34 is located below the first filler 32 for temporarily storing the solution obtained after the alkaline solution chemically reacts with the carbon dioxide gas. An end of the first pipeline 35 is in communication with the first temporary storage structure 34, and another end of the first pipeline 35 is in communication with the first spray structure 31. The first pump body 36 is disposed on the first pipeline 35 for pumping the solution entering the first temporary storage structure 34 into the first spray structure 31. In this way, the solution obtained after the alkaline solution chemically reacts with the carbon dioxide gas is stored in the first temporary storage structure 34, which on the one hand facilitates post-treatment of the above solution, and on the other hand may achieve recycling of the solution, so as to avoid wasting of resource. The solution is pumped into the first spray structure 31 through the first pump body 36, so as to ensure that the alkaline solution can be sprayed through the first spray structure 31 to react with CO₂, thereby improving spray reliability of the first spray structure 31 and operational reliability of the gas absorption system.

In this embodiment, the first temporary storage structure 34 and the first liquid supply device are of a same structure. In an early operation of the gas absorption system, an alkaline solution is disposed in the first temporary storage structure 34, the alkaline solution is sprayed to the first filler 32 through the first spray structure 31 to react with CO₂ in the air or the flue gas, and the solution obtained after the reacting is stored temporarily in the first temporary storage structure 34, so that the solution enters the first spray structure 31 again to continue spraying, so as to achieve recycling of the alkaline solution, until a concentration of carbonate in the alkaline solution reaches a preset concentration value, CO₂ capture and CO₂ absorption are stopped at this time, and the solution in the first temporary storage structure 34 is replaced with the alkaline solution.

It should be noted that a relationship between the first temporary storage structure 34 and the first liquid supply device is not limited thereto and may be adjusted according to working conditions and usage requirements. Optionally, the first temporary storage structure 34 is in communication with the first liquid supply device, so as to provide the alkaline solution for the first spray structure 31 through the first liquid supply device, and the solution, obtained after the alkaline solution reacts with the CO₂, is stored temporarily in the first temporary storage structure 34, so that the solution enters the first spray structure 31 again to continue spraying.

Optionally, there is one first temporary storage structure 34; or there are a plurality of first temporary storage structures 34, and the plurality of first temporary storage structures 34 are selectively put into use. In this way, during an operation of the gas absorption system, a usage state (putting into use or not putting into use) of the first temporary storage structure 34 may be adjusted according to the concentration of the carbonate in the first temporary storage structure 34, so as to supplement a fresh alkaline solution into the first spray structure 31, thereby achieving rapid and efficient CO₂ capture of the gas absorption system.

Optionally, there are a plurality of first temporary storage structures 34, and the gas absorption assembly 30 further includes a first pipeline 35, a plurality of first branch pipelines and a plurality of first control valves. A first end of the first pipeline 35 is in communication with the first spray structure 31. The plurality of first branch pipelines and the plurality of first temporary storage structures 34 are in a one-to-one correspondence, an end of each of the plurality of first branch pipelines is in communication with respective first temporary storage structures 34, and another end of each of the plurality of first branch pipelines is in communication with a second end of the first pipeline 35. The plurality of first control valves and the plurality of first branch pipelines are in a one-to-one correspondence, and each of the plurality of first control valves is configured to control an on-off state of respective first branch pipelines. At any time, at least one of the plurality of first control valves is in an open state. In this way, the on-off state of the first branch pipeline is controlled by the first control valve corresponding to the first branch pipeline, so as to control a usage state of the first temporary storage structure 34 in communication with the first branch pipeline, thereby making it easier and simpler for the workers to control the usage state of the first temporary storage structure 34, and thus reducing control difficulty. Adopting the above arrangement enables the plurality of first temporary storage structures 34 to be connected in parallel, and at any time, the at least one of the plurality of temporary storage structures 34 is controlled to be put into use, so as to provide the alkaline solution for the first spray structure 31.

As shown in FIG. 3 to FIG. 5, the gas pretreatment device 20 includes a second filler 21, a second liquid supply device (for example, a centrifugal pump, a gear pump or a magnetic drive pump) and a second spray structure 22. The second filler 21 is disposed opposite to the intake port 11. The second spray structure 22 is located above the second filler 21, and the second liquid supply device is in communication with the second spray structure 22. Specifically, the second spray structure 22 is configured to spray water, in a process of filtering impurities in the air or the flue gas by the gas pretreatment device 20, disposal of the second filler 21 provides sufficient contact surface for the impurities in the air or the flue gas and water, so as to ensure that the water can sink the impurities, thereby preventing the impurities from entering the gas absorption assembly 30.

Specifically, after the gas passes through the gas pretreatment device 20, a humidity of the gas may be increased, so as to reduce an evaporation rate of water in the gas absorption system, thereby reducing a loss of deionized water, and thus reducing a cost of capturing CO₂.

In this embodiment, the second liquid supply device is configured to supply tap water.

Optionally, the second spray structure 22 is a nozzle.

Optionally, the second filler 21 is a thin-film water-spraying filler.

Optionally, the second water collector 23 is a PVC water collector.

As shown in FIG. 3 to FIG. 5, the gas absorption assembly 30 further includes a first main pipeline 51 and a second branch pipeline 52. The first main pipeline 51 is connected to the first pipeline 35, there are a plurality of second branch pipelines 52, and each of the plurality of second branch pipelines 52 is connected to the first main pipeline 51. There are a plurality of first spray structures 31, and each of the plurality of second branch pipelines 52 is provided with a plurality of first spray structures 31.

As shown in FIG. 3 to FIG. 5, the gas pretreatment device 20 further includes a second water collector 23. The second water collector 23 is disposed opposite to the second filler 21. In this way, the second water collector 23 is configured to recover water vapor in the housing 10, so as to reduce fine water droplet drift carried in the gas discharged through the exhaust port 12, which can effectively prevent a loss of liquid water caused by a phenomenon of water splashing at the exhaust port 12.

Optionally, there is one second water collector 23; or, there are a plurality of second water collectors 23, at least one of the plurality of second water collectors 23 is located at a first side of the second filler 21, and at least one another of the plurality of second water collectors 23 is located at a second side of the second filler 21. In this way, adopting the above arrangement makes selection of an amount of second water collectors 23 more flexible, so as to meet different usage requirements and working conditions, thereby improving preparation flexibility of the workers. Disposal of the plurality of second water collectors 23 can improve recovery efficiency of water vapor, which further prevents a loss of liquid water caused by a phenomenon of water splashing at the exhaust port 12.

In this embodiment, there are two second water collectors 23, a second water collector 23 is located at the first side of the second filler 21, and another second water collector 23 is located at the second side of the second filler 21, so as to fully recover water vapor in the housing 10.

It should be noted that of the amount of second water collectors 23 is not limited thereto and may be adjusted according to working conditions and usage requirements. Optionally, the amount of second water collectors 23 is three, four, five and multiple.

As shown in FIG. 3 to FIG. 5, the gas pretreatment device 20 further includes a second temporary storage structure 24 (for example, a stainless steel alkaline solution storage tank or a stainless steel alkaline storage vessel), a second pipeline 25 and a second pump body 26 (for example, a centrifugal pump, a reciprocating pump, a rotary pump or a fluid action pump). The second temporary storage structure 24 is located below the second filler 21 for temporarily storing liquid flowing out through the second filler 21. An end of the second pipeline 25 is in communication with the second spray structure 22, and another end of the second pipeline 25 is in communication with the second temporary storage structure 24. The second pump body 26 is disposed on the second pipeline 25 for pumping the liquid entering the second temporary storage structure 24 into the second spray structure 22. In this way, water flowing out through the second filler 21 is stored in the second temporary storage structure 24, so as to achieve recycling of water, thereby avoiding waste of resource. The water is pumped into the second spray structure 22 through the second pump body 26, so as to ensure that water can be sprayed through the second spray structure 22 to sink the impurities, thereby improving spray reliability of the second spray structure 22 and operational reliability of the gas pretreatment device 20.

Optionally, the second temporary storage structure 24 includes a first temporary storage body and a first baffle plate. The first baffle plate is disposed inside the first temporary storage body for dividing an inner cavity of the first temporary storage body into a third sub-accommodating cavity and a fourth sub-accommodating cavity, the third sub-accommodating cavity is located below the second filler 21, and the fourth sub-accommodating cavity is in communication with the second pipeline 25. The first baffle plate is provided with an overflow hole, and the third sub-accommodating cavity is in communication with the fourth sub-accommodating cavity through the overflow hole; or an overflow portion is disposed between the first baffle plate and the first temporary storage body, and the third sub-accommodating cavity is in communication with the fourth sub-accommodating cavity through the overflow portion. In this way, adopting the above arrangement of the first baffle plate ensures that after the impurities are sprayed through the second spray structure 22, the impurities entering the third sub-accommodating cavity are fully deposited in the third sub-accommodating cavity, thereby preventing the second spray structure 22 from being blocked due to the impurities entering the second pipeline 25, and thus improving spray efficiency of the second spray structure 22. Adopting the above arrangement makes an overflow mode of liquid in the second temporary storage structure 24 more diverse, so as to meet different usage requirements and working conditions, thereby improving preparation flexibility of the workers.

Optionally, the second filler 21 includes a plurality of first sub-filler sheets, adjacent two first sub-filler sheets are disposed in a staggered manner and form a flow passage, a surface of each of the plurality of first sub-filler sheets is provided with an interference flow convex portion or an interference flow concave portion located in the flow passage. In this way, liquid and gas mixing with the impurities gather in the flow passage, and adopting the above arrangement of the interference flow convex portion or the interference flow concave portion makes the gas flow turbulentially at the interference flow convex portion or the interference flow concave portion, which further increases a contact area between the gas and the liquid, so as to ensure that the impurities mixed in the gas are in contact with the liquid as much as possible and are impacted by the liquid into the second temporary storage structure 24.

In other embodiments not shown in the accompanying drawings, the gas absorption system further includes a filter screen or a filter membrane located between the gas pretreatment device 20 and the intake port 11. In this way, with the above arrangement, a preliminarily filtration is performed by the filter screen or the filter membrane, and a secondary filtration is performed by the gas pretreatment device 20, thereby improving overall filtering efficiency of the gas absorption system.

Optionally, a bottom surface of the first temporary storage structure 34 is provided with a flow guidance slope. In this way, adopting the above arrangement makes the solution collect at a relatively low position on a bottom surface of the first temporary storage structure 34, thereby facilitating entry of the above solution into the first pipeline 35, and thus avoiding increasing cleaning difficulty for the workers due to accumulation of the solution at a dead zone of the first temporary storage structure 34.

In this embodiment, the bottom surface of the first temporary storage structure 34 is an inclined surface. In this way, adopting the above arrangement makes the bottom surface of the first temporary storage structure 34 easier to process and implement, thereby reducing a preparation cost of the gas absorption system.

In other embodiments not shown in the accompanying drawings, the bottom surface of the first temporary storage structure 34 is a conical surface.

In this embodiment, the second temporary storage structure 24 and the second liquid supply device are of a same structure, so as to reduce an amount of structures of the gas absorption system, which facilitates disassembly and maintenance of the gas absorption system for the workers.

It should be noted that a relationship between the second temporary storage structure 24 and the second liquid supply device is not limited thereto and may be adjusted according to working conditions and usage requirements. Optionally, the second temporary storage structure 24 is in communication with the second liquid supply device, so as to provide water for the second spray structure 22 through the second liquid supply device, and water and impurities flowing out through the second filler 21 are stored temporarily in the second temporary storage structure 24, so that the water enters the second spray structure 22 again to continue spraying.

As shown in FIG. 3, the housing 10 is provided with an accommodating cavity 13, the intake port 11 is in communication with the exhaust port 12 through the accommodating cavity 13, and the gas absorption assembly 30 is located inside the accommodation cavity 13. There is one intake port 11, and there is one gas pretreatment device 20; or there are a plurality of intake ports 11, the plurality of intake ports 11 are disposed around the accommodating cavity 13, there are a plurality of gas pretreatment devices 20, and the plurality of gas pretreatment devices 20 and the plurality of intake ports 11 are in a one-to-one correspondence. In this way, adopting the above arrangement makes selection of an amount of intake ports 11 more flexible, so as to meet different usage requirements and working conditions, thereby improving preparation flexibility of the workers.

In this embodiment, there are two intake ports 11, an intake port 11 is located at a side of the accommodation cavity 13, and another intake port 11 is located at another side of the accommodation cavity 13, there are two gas pretreatment devices 20, and the two gas pretreatment devices 20 and the two intake ports 11 are in a one-to-one correspondence. Each of the gas pretreatment devices 20 is configured to filter impurities in the air or the flue gas entering through respective intake ports 11, so as to ensure that all the air or all the flue gas entering the gas absorption system are filtered for impurities, thereby avoiding affecting CO₂ capture efficiency of the gas absorption system due to accumulation of impurities in the gas absorption system.

It should be noted that selection of an amount of intake ports 11 is not limited thereto and may be adjusted according to working conditions and usage requirements. Optionally, the amount of intake ports 11 is three, four, five and multiple.

It should be noted that selection of an amount of gas pretreatment devices 20 is not limited thereto, as long as the amount of gas pretreatment devices 20 is consistent with the amount of intake ports 11.

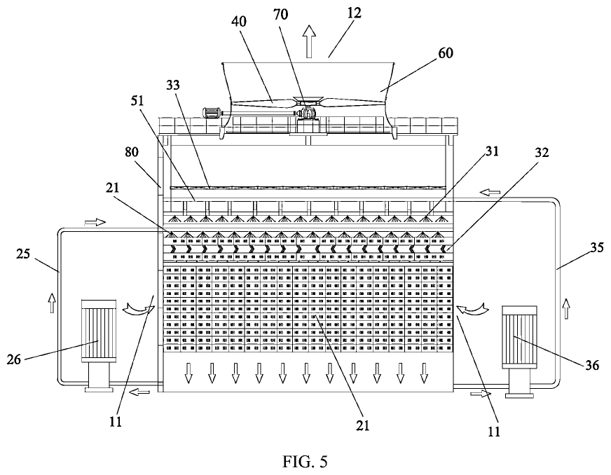

As shown in FIG. 3 and FIG. 5, the gas absorption system further includes a gas delivery device 40 and a first detection device (for example, a gas flow analyzer or a gas humidity monitor). The gas delivery device 40 is disposed at at least one of the exhaust port 12 and the intake port 11, gas can be delivered to an outside of the gas absorption system through the intake port 11. The first detection device is disposed inside the first temporary storage structure 34 for detecting a concentration of carbonate of a solution. In a case that a detection value of the first detection device reaches a first preset concentration value, the gas delivery device 40 is controlled to stop running. In this way, during an operation of the gas absorption system, in the case that the detection value of the first detection device reaches the preset concentration value, it is determined that the gas absorption system has completed capture and absorption of CO₂ in the air or the flue gas, and the gas absorption system is controlled to stop exhausting gas at this time; or it is determined that capture of CO₂ by an alkaline solution is saturated, and the gas absorption system is controlled to supply the alkaline solution at this time.

Optionally, the gas delivery device 40 includes a fan, and the fan is disposed at the exhaust port 12; and/or the gas delivery device 40 includes a compressor, and the compressor is disposed at the intake port 11. In this way, with the above arrangement of the fan, gas, obtained after the absorption and located in the gas absorption system, can be sucked out of the gas absorption system, so as to ensure that gas can smoothly flow in the gas absorption system. The compressor is configured to compress gas at the intake port into high-pressure gas, and then the high-pressure gas enters the gas absorption system, thereby increasing a flow rate of the gas, and thus improving CO₂ capture efficiency of the gas absorption system.

In this embodiment, the gas delivery device 40 includes the fan, and the fan is disposed at the exhaust port 12.

Optionally, in the case that the detection value of the first detection device reaches the preset concentration value, it is determined that capacity of CO₂ capture and CO₂ absorption of the alkaline solution in the first temporary storage structure 34 that has been put into use cannot meet usage requirements of the gas absorption system, and the first temporary storage structure 34 that has been put into use is replaced at this time, so as to improve stability of capability of capturing and absorbing CO₂ by the gas absorption system.

Optionally, the gas absorption system further includes a second detection device (for example, a liquid level gauge or an acid-base indicator). The second detection device is disposed inside the first temporary storage structure 34 for detecting a concentration of hydroxide of a solution; and in a case that a detection value of the second detection device is less than a second preset concentration value, the first pump body 36 is controlled to start. In this way, in the case that the detection value of the second detection device is less than the second preset concentration value, it is determined that the alkaline solution in the first temporary storage structure 34 is saturated and CO₂ capture efficiency cannot meet usage requirements, and the alkaline solution is supplemented into the first temporary storage structure 34 by an alkaline solution pump at this time, and until the detection value of the second detection device reaches a required value, the supplement of the alkaline solution is stopped.

Optionally, the gas absorption assembly 30 further includes a first liquid level gauge, and the first liquid level gauge is disposed in the first temporary storage structure 34 for detecting a height of a solution in the first temporary storage structure 34. In a case that a liquid level is lower than a first liquid level value, water is supplemented into the first temporary storage structure 34 by a water replenishment pump, and in a case that the liquid level reaches a preset liquid level, the supplement of the water is stopped.

Optionally, the gas pretreatment device 20 further includes a second liquid level gauge, and the second liquid level gauge is disposed in the second temporary storage structure 24 for detecting a height of a solution in the second temporary storage structure 24. In a case that a liquid level is lower than a second liquid level value, water is supplemented into the second temporary storage structure 24 by a water replenishment pump, and in a case that the liquid level reaches a preset liquid level, the supplement of the water is stopped.

As shown in FIG. 3 and FIG. 5, the gas absorption system further includes a wind duct 60 and a gearbox 70. The wind duct 60 is connected to the housing 10 and is located at the exhaust port 12 for guiding a flow of gas discharged through the exhaust port 12. The gearbox 70 is connected to a fan by means of a driving manner, so as to drive the fan to operate.

Optionally, there is one first filler 32; or, there are a plurality of first fillers 32, and the plurality of first fillers 32 are disposed at intervals along a length direction of the gas absorption system.

Optionally, there is one second filler 21; or, there are a plurality of second fillers 21, and the plurality of second fillers 21 are disposed at intervals along a length direction of the gas absorption system.

Optionally, a spray density of the first spray structure 31 ranges from 0 m³/m²*h to 20 m³/m²*h, and deionized water is used.

Optionally, the gas absorption system further includes a hydroturbine and a generator. The hydroturbine is located below the first temporary storage structure 34, and liquid inside the first temporary storage structure 34 flows to the hydroturbine through the flow guidance slope. The generator is connected to the hydroturbine. In this way, during an operation of the gas absorption system, the hydroturbine is driven to rotate by a liquid potential energy, thereby achieving a power generation function of the generator, and the generator may supply power to the first pump body 36 and the second pump body 26, so as to recycle the liquid potential energy, thereby reducing overall energy consumption of the gas absorption system.

Optionally, the gas absorption system further includes a stirring device (for example, an anchor agitator, a propeller agitator, a butterfly agitator or a turbine agitator). The stirring device is disposed inside the first temporary storage structure 34. In this way, adopting the arrangement of the stirring device makes mixing of fresh water and fresh alkaline solution more uniform.

In this embodiment, the method for capturing the carbon dioxide is applied to a gas absorption system, and the gas absorption system is configured to absorb carbon dioxide gas. The gas absorption system includes a housing and a gas absorption assembly, the housing is provided with an intake port and an exhaust port, and the intake port and exhaust port are disposed opposite to each other. The gas absorption assembly is disposed inside the housing and is located downstream of a gas pretreatment device, and the gas absorption assembly includes a liquid supply device and a spray structure that are in communication with each other for providing an alkaline solution; and the alkaline solution flowing out through the spray structure chemically reacts with carbon dioxide gas in gas to absorb the carbon dioxide gas.

Optionally, the gas absorption system is a cross-flow absorption system or a countercurrent absorption system. The cross-flow absorption system is that an intake direction of air or flue gas is consistent with an exhaust direction of the air or the flue gas. The countercurrent absorption system is that there is an included angle between the intake direction of the air or the flue gas and the exhaust direction of the air or the flue gas.

Optionally, the spray structure is a nozzle.

Optionally, the gas absorption assembly includes a filler and a water collector. The filler is located below the spray structure. The water collector is disposed opposite to the filler. In this way, disposal of the filler provides sufficient contact surface for CO₂ in the air or the flue gas and the alkaline solution, so that the CO₂ in the air or the flue gas fully reacts with the alkaline solution, which further improves efficiency of capturing and absorbing CO₂ by the gas absorption assembly. The water collector is configured to recover absorption liquid in the gas absorption assembly to reduce fine water droplet drift carried in gas discharged through the gas absorption assembly. Adopting the above arrangement makes positioning of the water collector more flexible, so as to meet different usage requirements and working conditions, thereby improving preparation flexibility of the workers.

Specifically, the alkaline solution falls in a form of droplets from the spray structure into the filler, and flows in a form of a liquid film in the filler, and the alkaline solution falls in the form of the droplets into the first temporary storage structure after passing through the filler. The pretreated gas is in full contact with the alkaline solution in a water spraying area and the filler of the gas absorption assembly, so that CO₂ in the air or the flue gas chemically reacts with the alkaline solution, thereby capturing the CO₂. The captured CO₂ exists in the first temporary storage structure in a form of carbonate and bicarbonate ions, and the first pump body or the third pump body is configured to deliver the solution obtained after the reacting to a subsequent process system for processing. The first temporary storage structure is provided with a first liquid supply device to supplement water and hydroxide consumed in the solution.

Optionally, the filler is a thin-film water-spraying filler.

Optionally, the water collector is a PVC water collector, and the water collector is supported by a bracket.

In this embodiment, the gas absorption assembly further includes a first temporary storage structure. The first temporary storage structure is located below the filler for temporarily storing the solution obtained after the alkaline solution chemically reacts with the carbon dioxide gas. In this way, the solution, obtained after the alkaline solution chemically reacts with the carbon dioxide gas, is stored in the first temporary storage structure, which on the one hand facilitates post-treatment of the above solution, and on the other hand may achieve recycling of the solution, so as to avoid wasting of resource.

In this embodiment, the first temporary storage structure and the liquid supply device are of a same structure. In an early operation of the gas absorption system, an alkaline solution is disposed in the first temporary storage structure, the alkaline solution is sprayed to the filler through the spray structure to react with CO₂ in the air or the flue gas, and the solution obtained after the reacting is stored temporarily in the first temporary storage structure, so that the solution enters the spray structure again to continue spraying, so as to achieve recycling of the alkaline solution, until a concentration of carbonate in the alkaline solution reaches a preset concentration value, CO₂ capture and CO₂ absorption are stopped at this time, and the solution in the first temporary storage structure is replaced with the alkaline solution.

It should be noted that a relationship between the first temporary storage structure and the liquid supply device is not limited thereto and may be adjusted according to working conditions and usage requirements. Optionally, the first temporary storage structure is in communication with the liquid supply device, so as to provide the alkaline solution for the spray structure through the liquid supply device, and the solution, obtained after the alkaline solution reacts with the CO₂, is stored temporarily in the first temporary storage structure, so that the solution enters the spray structure again to continue spraying.

Optionally, there is one first temporary storage structure; or there are a plurality of first temporary storage structures, and the plurality of first temporary storage structures are selectively put into use. In this way, during an operation of the gas absorption system, a usage state (putting into use or not putting into use) of the first temporary storage structure may be adjusted according to the concentration of the carbonate in the first temporary storage structure, so as to supplement a fresh alkaline solution into the spray structure, thereby achieving rapid and efficient CO₂ capture of the gas absorption system.

Optionally, there are a plurality of first temporary storage structures, and the gas absorption assembly further includes a main pipeline, a plurality of branch pipelines and a plurality of control valves. A first end of the main pipeline is in communication with the spray structure. The plurality of branch pipelines and the plurality of first temporary storage structures are in a one-to-one correspondence, an end of each of the plurality of branch pipelines is in communication with respective first temporary storage structures, and another end of each of the plurality of branch pipelines is in communication with a second end of the main pipeline. The plurality of control valves and the plurality of branch pipelines are in a one-to-one correspondence, and each of the plurality of control valves is configured to control an on-off state of respective branch pipelines. At any time, at least one of the plurality of control valves is in an open state. In this way, the on-off state of the branch pipeline is controlled by the control valve corresponding to the branch pipeline, so as to control a usage state of the first temporary storage structure in communication with the branch pipeline, thereby making it easier and simpler for the workers to control the usage state of the first temporary storage structure, and thus reducing control difficulty. Adopting the above arrangement enables the plurality of first temporary storage structures to be connected in parallel, and at any time, the at least one of the plurality of temporary storage structures is controlled to put into use, so as to provide the alkaline solution for the spray structure.

In this embodiment, the gas absorption assembly further includes a first pump body or a third pump body, the first pump body or the third pump body is disposed on the main pipeline or the branch pipeline, and the first pump body or the third pump body is configured to pump a solution entering the first temporary storage structure into the spray structure. In this way, the solution is pumped into the spray structure through the first pump body or the third pump body, so as to ensure that the alkaline solution can be sprayed through the spray structure to react with CO₂, thereby improving spray reliability of the spray structure, and thus improving operational reliability of the gas absorption system.

In this embodiment, the gas absorption system further includes an electrolysis device (for example, an ion-exchange membrane alkaline solution electrolytic cell), the electrolysis device is located downstream of the first temporary storage structure, and a carbonic acid solution discharged through the first temporary storage structure is electrolyzed by the electrolysis device, so that potassium hydroxide and hydrogen are generated at a cathode of the electrolysis device, and mixing gas including oxygen and carbon dioxide is generated at an anode of the electrolysis device; and the potassium hydroxide is used for absorbing the carbon dioxide in the gas absorption system.

### Embodiment 2

Differences between the method for capturing the carbon dioxide in embodiment 2 and the method for capturing the carbon dioxide in the embodiment 1 are that: a value of m, a value of n and electric charge applied to an electrolysis device.

In this embodiment, the value of m is 0.3 mol/L, the value of n is 5.5 mol/L, the electric charge applied to the electrolysis device is controlled, so that electric charge obtained by 1 mol of a carbonate solution is 55.1 A·h, and power consumption of the electrolysis device is measured to be 3.36 kWh/kgCO₂, and a molar yield ratio of carbon dioxide gas to hydrogen is 1:1.03.

### Embodiment 3

Differences between the method for capturing the carbon dioxide in embodiment 3 and the method for capturing the carbon dioxide in the embodiment 1 are that: a value of m, a value of n and electric charge applied to an electrolysis device.

In this embodiment, the value of m is 5 mol/L, the value of n is 1 mol/L, power consumption of the electrolysis device is measured to be 11.46 kWh/kgCO₂, the electric charge applied to the electrolysis device is controlled, so that electric charge obtained by 1 mol of a carbonate solution is 187.6 A·h, and a molar yield ratio of carbon dioxide gas to hydrogen is 1:3.5.

### Embodiment 4

Differences between the method for capturing the carbon dioxide in embodiment 4 and the method for capturing the carbon dioxide in the embodiment 1 are that: a value of m, a value of n and electric charge applied to an electrolysis device.

In this embodiment, the value of m is 0.1 mol/L, the value of n is 5.3 mol/L, the electric charge applied to the electrolysis device is controlled, so that electric charge obtained by 1 mol of a carbonate solution is 54.1 A·h, and power consumption of the electrolysis device is measured to be 3.29 kWh/kgCO₂, and a molar yield ratio of carbon dioxide gas to hydrogen is 1:1.

### Embodiment 5

Differences between the method for capturing the carbon dioxide in embodiment 5 and the method for capturing the carbon dioxide in the embodiment 1 are that: a value of m, a value of n and electric charge applied to an electrolysis device.

In this embodiment, the value of m is 2.5 mol/L, the value of n is 0.5 mol/L, the electric charge applied to the electrolysis device is controlled, so that electric charge obtained by 1 mol of a carbonate solution is 187.6 A·h, and power consumption of the electrolysis device is measured to be 11.83 kWh/kgCO₂, and a molar yield ratio of carbon dioxide gas to hydrogen is 1:3.5.

### Embodiment 6

Differences between the method for capturing the carbon dioxide in embodiment 6 and the method for capturing the carbon dioxide in the embodiment 1 are that: a value of m, a value of n and electric charge applied to an electrolysis device.

In this embodiment, the electric charge applied to the electrolysis device is controlled, so that electric charge obtained by 1 mol of a carbonate solution is 107.2 A·h, and power consumption of the electrolysis device is measured to be 6.63 kWh/kgCO₂, and a molar yield ratio of carbon dioxide gas to hydrogen is 1:2.01.

The results of power consumption of an electrolysis device and a molar yield ratio of carbon dioxide gas to hydrogen respectively measured in all the above embodiments are summarized in Table 1.

Table 1 is a table for comparing the results of the power consumption of the electrolysis device and the molar yield ratio of the carbon dioxide gas to the hydrogen in various embodiments.

TABLE 1

| | Power consumption of | Molar yield ratio of carbon |
|---|---|---|
| | electrolysis device | dioxide gas to hydrogen |
| | (kWh/kgCO₂) | (vol % ) |
| Embodiment 1 | 3.30 | 1:1.01 |
| Embodiment 2 | 3.36 | 1:1.03 |
| Embodiment 3 | 11.46 | 1:3.5 |
| Embodiment 4 | 3.29 | 1:1 |
| Embodiment 5 | 11.83 | 1:3.5 |
| Embodiment 6 | 6.63 | 1:2.01 |

Through the above comparison, the following conclusions can be obtained.

Firstly, from a comparison of the embodiment 3 and the embodiment 5, it can be seen that the at least one of the concentration of the hydroxide and the concentration of the carbonate of the solution in the temporary storage structure is precisely controlled through the method for capturing the carbon dioxide in the embodiments, and in a case that the solution in the temporary storage structure is sent to the electrolysis device for the electrolysis, a concentration range of the hydroxide of the solution and a concentration range of the carbonate of the solution include but are not limited to the preferred ranges of the present disclosure. Limiting the concentration range of the hydroxide and the concentration range of the carbonate within the preferred ranges of the present disclosure is beneficial for reducing energy consumption of an electrolysis device, thereby reducing a process cost of a system for capturing carbon dioxide, and thus effectively solving problems in that capture efficiency of carbon dioxide gas and overall energy consumption of a system for capturing carbon dioxide are relatively difficult to control in the related technologies.

Secondly, from a comparison of the embodiment 1 to the embodiment 6, it can be seen that the molar yield ratio of the carbon dioxide gas to the hydrogen during the process of the electrolysis is adjustable through the method for capturing the carbon dioxide in the embodiments, and the molar yield ratio of the carbon dioxide gas to the hydrogen in a system may be flexibly adjusted according to actual demands of a device for utilizing carbon dioxide gas located downstream, thereby greatly improving an application scope of a system.

### Embodiment 7

Differences between the gas absorption system in the embodiment 7 and the gas absorption system in the embodiment 1 are that: an intake direction and an exhaust direction of the gas absorption system.

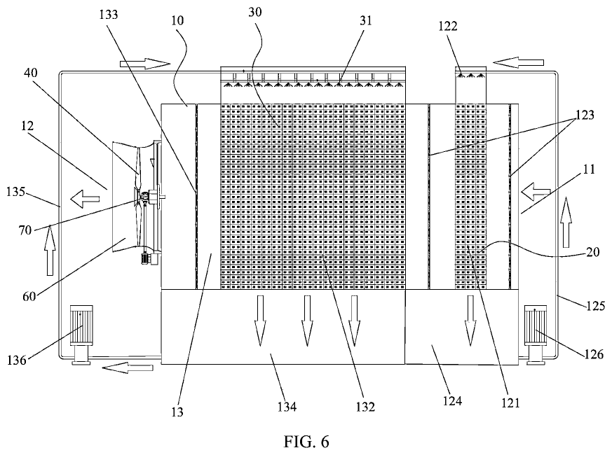

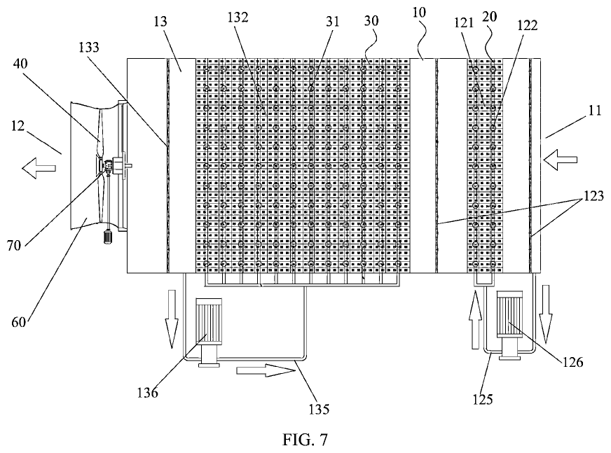

As shown in FIG. 6 and FIG. 7, the gas absorption system is configured to absorb carbon dioxide gas in environment, the gas absorption system includes a housing 10, a gas pretreatment device 20, a gas absorption assembly 30 and a gas delivery device 40. The housing 10 is provided with an intake port 11 and an exhaust port 12 that are in communication with each other, and the intake port 11 and the exhaust port 12 are disposed opposite to each other. The gas pretreatment device 20 is disposed inside the housing 10 and is located at the intake port 11 for filtering impurities in gas entering the intake port 11. The gas absorption assembly 30 is disposed inside the housing 10 and is located downstream of the gas pretreatment device 20. The gas absorption assembly 30 includes a first liquid supply device and a first spray structure 31, and the first liquid supply device is in communication with the first spray structure 31, so as to provide an alkaline solution. The alkaline solution flowing out through the first spray structure 31 chemically reacts with carbon dioxide gas in gas to absorb the carbon dioxide gas. The gas delivery device 40 is disposed at at one of the exhaust port 12 and the intake port 11, gas can be delivered to an outside of the gas absorption system through the intake port 11.

Specifically, the gas pretreatment device 20 is disposed inside the housing 10 and is located at the intake port 11, and the gas absorption assembly 30 is located downstream of the gas pretreatment device 20. In this way, during an operation of the gas absorption system, after air or flue gas enters the gas absorption system through the intake port 11, the air or the flue gas passes through the gas pretreatment device 20 first, and impurities in the air or the flue gas are filtered by the gas pretreatment device 20, which avoids accumulation of the above impurities in the gas absorption system, and avoids affecting efficiency of absorbing and capturing carbon dioxide gas by the gas absorption system caused by the above impurities entering the gas absorption assembly 30, so as to solve problems in that the impurities such as solid particles mixing in the air or the flue gas are easily accumulated in a system for capturing CO₂ in the related technologies, and thus reducing an operation cost and a maintenance cost of the gas absorption system. Absorbing the impurities in the air or the flue gas can also improve a purity of a solution obtained after the alkaline solution chemically reacts with the carbon dioxide gas, thereby reducing a cost of a post-treatment process.

Optionally, the gas delivery device 40 includes a fan, the fan is disposed at the exhaust port 12; and/or the gas delivery device 40 includes a compressor, and the compressor is disposed at the intake port 11. In this way, with the above arrangement of the fan, gas, obtained after the absorption and located in the gas absorption system, can be sucked out of the gas absorption system, so as to ensure that gas can smoothly flow in the gas absorption system. The compressor is configured to compress gas at the intake port 11 into high-pressure gas, and then the high-pressure gas enters the gas absorption system, thereby increasing a flow rate of the gas, and thus improving CO₂ capture efficiency of the gas absorption system.

In this embodiment, the gas delivery device 40 includes the fan, and the fan is disposed at the exhaust port 12.

Optionally, the alkaline solution is one of sodium hydroxide, potassium hydroxide, potassium carbonate and sodium carbonate, and solutions with different concentrations may be prepared with deionized water as needed.

In this embodiment, an alkaline solution is used as an absorbent, which not only can capture CO₂ with a high concentration, but also can capture CO₂ with a low concentration, so as to realize the capturing of CO₂ with a wide concentration range.

In this embodiment, the gas absorption system is a cross-flow absorption system, i.e., an intake direction of the air or the flue gas is consistent with an exhaust direction of the air or the flue gas.

In this embodiment, there are a plurality of first spray structures 31, the plurality of first spray structures 31 are disposed at intervals along a flow direction of the gas in the gas absorption system, thereby increasing a quantity of the alkaline solution sprayed out through the first spray structures 31, and thus ensuring that the alkaline solution sprayed out through the first spray structures 31 can fully capture and absorb CO₂ in the air or the flue gas.

Optionally, the first spray structure 31 is a nozzle.

Optionally, the gas absorption assembly 30 includes a third filler 132 and a third water collector 133. The third filler 132 is located below the first spray structure 31. The third water collector 133 is disposed opposite to the third filler 132. The third water collector 133 is located between the exhaust port 12 and the third filler 132; and/or the third water collector 133 is located between the third filler 132 and the gas pretreatment device 20. In this way, disposal of the third filler 132 provides sufficient contact surface for the CO₂ and the alkaline solution, so that the CO₂ in the air or the flue gas fully reacts with the alkaline solution, which further improves efficiency of capturing and absorbing CO₂ by the gas absorption assembly 30. The first water collector 33 is configured to recover water vapor in the housing 10 to reduce fine water droplet drift carried in the gas discharged through the exhaust port 12, which can effectively prevent a loss of liquid water caused by a phenomenon of water splashing at the exhaust port 12. Adopting the above arrangement makes positioning of the third water collector 133 more flexible, so as to meet different usage requirements and working conditions, thereby improving preparation flexibility of the workers.

Specifically, the alkaline solution falls in a form of droplets from the first spray structure 31 into the third filler 132, and flows in a form of a liquid film in the third filler 132, and the alkaline solution falls in the form of the droplets into the third temporary storage structure 134 after passing through the third filler 132. The gas enters the gas absorption assembly 30 after the impurities carried in the air or the flue gas are removed through the gas pretreatment device 20, and the pretreated gas is in full contact with the alkaline solution in a water spraying area and the third filler 132 of the gas absorption assembly 30, so that CO₂ in the air or the flue gas chemically reacts with the alkaline solution, thereby capturing the CO₂. The captured CO₂ exists in the third temporary storage structure 134 in a form of carbonate and bicarbonate ions, and the third pump body 136 is configured to deliver the solution obtained after the reacting to a subsequent process system for processing. The third temporary storage structure 134 is provided with a first liquid supply device to supplement water and hydroxide consumed in the solution.

In this embodiment, the third water collector 133 is located between the exhaust port 12 and the third filler 132 for recovering fine water droplet drift carried in the gas discharged through the exhaust port 12.

It should be noted that the position of the third water collector 133 is not limited thereto and may be adjusted according to working conditions and usage requirements.

In other embodiments not shown in the accompanying drawings, the third water collector 133 is located between the third filler 132 and the gas pretreatment device 20.

In other embodiments not shown in the accompanying drawings, there are a plurality of third water collectors 133, at least one of the plurality of third water collectors 133 is located between the exhaust port 12 and the third filler 132, and at least one another of the plurality of third water collectors 133 is located between the third filler 132 and the gas pretreatment device 20 for fully recovering water vapor in the housing 10.

Optionally, the third filler 132 is a thin-film water-spraying filler.

Optionally, the third water collector 133 is a PVC water collector, and the third water collector 133 is supported by a bracket.

As shown in FIG. 6, the gas absorption assembly 30 further includes a third temporary storage structure 134. The third temporary storage structure 134 is located below the third filler 132 for temporarily storing the solution obtained after the alkaline solution chemically reacts with the carbon dioxide gas. In this way, the solution obtained after the alkaline solution chemically reacts with the carbon dioxide gas is stored in the third temporary storage structure 134, which on the one hand facilitates post-treatment of the above solution, and on the other hand may achieve recycling of the solution, so as to avoid wasting of resource.

In this embodiment, the third temporary storage structure 134 and the first liquid supply device are of a same structure. In an early operation of the gas absorption system, an alkaline solution is disposed in the third temporary storage structure 134, the alkaline solution is sprayed to the third filler 132 through the first spray structure 31 to react with CO₂ in the air or the flue gas, and the solution obtained after the reacting is stored temporarily in the third temporary storage structure 134, so that the solution enters the first spray structure 31 again to continue spraying, so as to achieve recycling of the alkaline solution, until a concentration of carbonate in the alkaline solution reaches a preset concentration value, CO₂ capture and CO₂ absorption are stopped at this time, and the solution in the third temporary storage structure 134 is replaced with the alkaline solution.

It should be noted that a relationship between the third temporary storage structure 134 and the first liquid supply device is not limited thereto and may be adjusted according to working conditions and usage requirements. Optionally, the third temporary storage structure 134 is in communication with the first liquid supply device, so as to provide the alkaline solution for the first spray structure 31 through the first liquid supply device, and the solution obtained after the alkaline solution reacts with the CO₂ is stored temporarily in the third temporary storage structure 134, so that the solution enters the first spray structure 31 again to continue spraying.

Optionally, there is one third temporary storage structure 134; or there are a plurality of third temporary storage structures 134, and the plurality of third temporary storage structures 134 are selectively put into use. In this way, during an operation of the gas absorption system, a usage state (putting into use or not putting into use) of the third temporary storage structure 134 may be adjusted according to a concentration of carbonate in the third temporary storage structure 134, so as to supplement a fresh alkaline solution into the first spray structure 31, thereby achieving rapid and efficient CO₂ capture of the gas absorption system.

Optionally, there are a plurality of third temporary storage structures 134, and the gas absorption assembly 30 further includes a second main pipeline 135, a plurality of third branch pipelines and a plurality of control valves. A first end of the second main pipeline 135 is in communication with the first spray structure 31. The plurality of third branch pipelines and the plurality of third temporary storage structures 134 are in a one-to-one correspondence, an end of each of the plurality of third branch pipelines is in communication with respective third temporary storage structures 134, and another end of each of the plurality of third branch pipelines is in communication with a second end of the second main pipeline 135. The plurality of control valves and the plurality of third branch pipelines are in a one-to-one correspondence, and each of the plurality of control valves is configured to control an on-off state of respective third branch pipelines. At any time, at least one of the plurality of control valves is in an open state. In this way, the on-off state of the third branch pipeline is controlled by the control valve corresponding to the third branch pipeline, so as to control a usage state of the third temporary storage structure 134 in communication with the third branch pipeline, thereby making it easier and simpler for the workers to control the usage state of the third temporary storage structure 134, thereby reducing control difficulty. Adopting the above arrangement enables the plurality of third temporary storage structures 134 to be connected in parallel, and at any time, at least one of the plurality of third temporary storage structures 134 is controlled to put into use, so as to provide the alkaline solution for the first spray structure 31.

Optionally, the gas absorption assembly 30 further includes a third detection device disposed on the second main pipeline 135 for detecting a concentration of carbonate of a solution in the second main pipeline 135, and in a case that a detection value of the third detection device reaches a preset concentration value, a third branch pipeline corresponding to a third temporary storage structure 134 that has been put into use is controlled to be in a disconnected state by at least one control valve, and at least one another third temporary storage structure 134 is controlled to put into use by at least one another control valve. In this way, during an operation of the gas absorption system, in a case that a detection value of the third detection device reaches a preset concentration value, it is determined that capacity of CO₂ capture and CO₂ absorption of the alkaline solution in the third temporary storage structure 134 that has been put into use cannot meet usage requirements of the gas absorption system, and the third temporary storage structure 134 that has been put into use is replaced at this time, so as to improve stability of capability of capturing and absorbing CO₂ by the gas absorption system.

As shown in FIG. 6 and FIG. 7, the gas absorption assembly 30 further includes a third pump body 136. The third pump body 136 is disposed on one of the second main pipeline 135 and the third branch pipeline for pumping a solution entering the third temporary storage structure 134 into the first spray structure 31. In this way, the solution is pumped into the first spray structure 31 through the third pump body 136, so as to ensure that the alkaline solution can be sprayed through the first spray structure 31 to react with CO₂, thereby improving spray reliability of the first spray structure 31, and thus improving operational reliability of a system for capturing carbon dioxide. Optionally, the third pump body 136 is a first pump body.

As shown in FIG. 6 and FIG. 7, the gas pretreatment device 20 further includes a fourth filler 121, a third liquid supply device, a third spray structure 122 and a fourth water collector 123. The fourth filler 121 is disposed opposite to the intake port 11. The third spray structure 122 is located above the fourth filler 121, and the third liquid supply device is in communication with the third spray structure 122. The fourth water collector 123 is disposed opposite to the fourth filler 121. Specifically, the third spray structure 122 is configured to spray water, during a process of filtering impurities in the air or the flue gas by the gas pretreatment device 20, disposal of the fourth filler 121 provides sufficient contact surface for the impurities in the air or the flue gas and water, so as to ensure that the water can sink the impurities, thereby preventing the impurities from entering the gas absorption assembly 30. The fourth water collector 123 is configured to recover water vapor in the housing 10, so as to reduce fine water droplet drift carried in gas discharged through the exhaust port 12, which can effectively prevent a loss of liquid water caused by a phenomenon of water splashing at the exhaust port 12.

Specifically, after the gas passes through the gas pretreatment device 20, a humidity of the gas may be increased, so as to reduce an evaporation rate of water in the gas absorption system, thereby reducing a loss of deionized water, and thus reducing a cost of capturing CO₂.

In this embodiment, the second liquid supply device is configured to supply tap water.

Optionally, the third spray structure 122 is a nozzle.

Optionally, the fourth filler 121 is a thin-film water-spraying filler.

Optionally, the fourth water collector 123 is a PVC water collector.

Optionally, there is one fourth water collector 123; or, there are a plurality of fourth water collectors 123, at least one of the plurality of fourth water collectors 123 is located at a first side of the fourth filler 121, and at least one another of the plurality of fourth water collectors 123 is located at a second side of the fourth filler 121. In this way, adopting the above arrangement makes selection of an amount of fourth water collectors 123 more flexible, so as to meet different usage requirements and working conditions, thereby improving preparation flexibility of the workers. Disposal of the plurality of fourth water collectors 123 can improve recovery efficiency of water vapor, which further prevents a loss of liquid water caused by a phenomenon of water splashing at the exhaust port 12.

In this embodiment, there are two fourth water collectors 123, a fourth water collector 123 is located at the first side of the fourth filler 121, and another fourth water collector 123 is located at the second side of the fourth filler 121, so as to fully recover water vapor in the housing 10.

It should be noted that the amount of fourth water collectors 123 is not limited thereto and may be adjusted according to working conditions and usage requirements. Optionally, the amount of fourth water collectors 123 is three, four, five and multiple.

As shown in FIG. 6 to FIG. 7, the gas pretreatment device 20 further includes a fourth temporary storage structure 124, a third main pipeline 125 and a fourth pump body 126. The fourth temporary storage structure 124 is located below the fourth filler 121 for temporarily storing liquid flowing out through the fourth filler 121. An end of the third main pipeline 125 is in communication with the third spray structure 122, and another end of the third main pipeline 125 is in communication with the fourth temporary storage structure 124. The fourth pump body 126 is disposed on the third main pipeline 125 for pumping the liquid entering the fourth temporary storage structure 124 into the third spray structure 122. In this way, water flowing out through the fourth filler 121 is stored in the fourth temporary storage structure 124, so as to achieve recycling of the water, thereby avoiding waste of resource. The water is pumped into the third spray structure 122 through the fourth pump body 126, so as to ensure that the water can be sprayed through the third spray structure 122 to sink the impurities, thereby improving spray reliability of the third spray structure 122 and operational reliability of the gas pretreatment device 20.

Optionally, the fourth temporary storage structure 124 includes a second temporary storage body and a second baffle plate. The second baffle plate is disposed inside the second temporary storage body for dividing an inner cavity of the second temporary storage body into a first sub-accommodating cavity and a second sub-accommodating cavity, the first sub-accommodating cavity is located below the fourth filler 121, and the second sub-accommodating cavity is in communication with the third main pipeline 125. The second baffle plate is provided with an overflow hole, and the first sub-accommodating cavity is in communication with the second sub-accommodating cavity through the overflow hole; or an overflow portion is disposed between the second baffle plate and the second temporary storage body, and the first sub-accommodating cavity is in communication with the second sub-accommodating cavity through the overflow portion. In this way, adopting the above arrangement of the second baffle plate ensures that after the impurities are sprayed through the third spray structure 122, the impurities entering the first sub-accommodating cavity are fully deposited in the first sub-accommodating cavity, thereby preventing the third spray structure 122 from being blocked due to the impurities entering the third main pipeline 125, and thus improving spray efficiency of the third spray structure 122. Adopting the above arrangement makes an overflow mode of liquid in the fourth temporary storage structure 124 more diverse, so as to meet different usage requirements and working conditions, thereby improving preparation flexibility of the workers.

Optionally, the fourth filler 121 includes a plurality of second sub-filler sheets, adjacent two second sub-filler sheets are disposed in a staggered manner and form a flow passage, a surface of each of the plurality of second sub-filler sheets is provided with an interference flow convex portion or an interference flow concave portion located in the flow passage. In this way, liquid and gas mixing with the impurities gather in the flow passage, and adopting the above arrangement of the interference flow convex portion or the interference flow concave portion makes the gas flow turbulentially at the interference flow convex portion or the interference flow concave portion, which further increases a contact area between the gas and the liquid, so as to ensure that the impurities mixed in the gas are in contact with the liquid as much as possible and are impacted by the liquid into the fourth temporary storage structure 124.

In other embodiments not shown in the accompanying drawings, the gas pretreatment device 20 is a filter screen or a filter membrane. In this way, a preparation cost and preparation difficulty of the gas pretreatment device 20 are reduced with the above arrangement.

Optionally, a bottom surface of the third temporary storage structure 134 is provided with a flow guidance slope. In this way, adopting the above arrangement makes the solution collect at a relatively low position on a bottom surface of the third temporary storage structure 134, thereby facilitating entry of the above solution into the second pipeline 135, and thus avoiding increasing cleaning difficulty for the workers due to accumulation of the solution at a dead zone of the third temporary storage structure 134.

In this embodiment, the bottom surface of the third temporary storage structure 134 is an inclined surface. In this way, adopting the above arrangement makes the bottom surface of the third temporary storage structure 134 easier to process and implement, thereby reducing a preparation cost of the gas absorption system.

In other embodiments not shown in the accompanying drawings, the bottom surface of the third temporary storage structure 134 is a conical surface.

In this embodiment, the fourth temporary storage structure 124 and the third liquid supply device are of a same structure, so as to reduce an amount of structures of the gas absorption system, which facilitates disassembly and maintenance of the gas absorption system for the workers.

It should be noted that a relationship between the fourth temporary storage structure 124 and the third liquid supply device is not limited thereto and may be adjusted according to working conditions and usage requirements. Optionally, the fourth temporary storage structure 124 is in communication with the third liquid supply device, so as to provide water for the third spray structure 122 through the third liquid supply device, and water and impurities flowing out through the fourth filler 121 are stored temporarily in the fourth temporary storage structure 124, so that the water enters the third spray structure 122 again to continue spraying.

Optionally, the gas absorption assembly 30 further includes a first liquid level gauge, and the first liquid level gauge is disposed in the third temporary storage structure 134 for detecting a height of a solution in the third temporary storage structure 134. In a case that a liquid level is lower than a first liquid level value, water is supplemented into the third temporary storage structure 134 by a water replenishment pump, and in a case that the liquid level reaches a preset liquid level, the supplement of the water is stopped.

Optionally, the gas pretreatment device 20 further includes a second liquid level gauge, and the second liquid level gauge is disposed in the fourth temporary storage structure 124 for detecting a height of a solution in the fourth temporary storage structure 124. In a case that a liquid level is lower than a second liquid level value, water is supplemented into the fourth temporary storage structure 124 by a water replenishment pump, and in a case that the liquid level reaches a preset liquid level, the supplement of the water is stopped.

As shown in FIG. 6 and FIG. 7, the housing 10 is provided with an accommodating cavity 13, and the gas absorption assembly 30 is located inside the accommodation cavity 13. The gas absorption system further includes a wind duct 60 and a gearbox 70. The wind duct 60 is connected to the housing 10 and is located at the exhaust port 12 for guiding a flow of gas discharged through the exhaust port 12. The gearbox 70 is connected to a fan by means of a driving manner, so as to drive the fan to operate.

In this embodiment, wind enters from a side of the gas absorption system. The third temporary storage structure 134 is adjacent to the fourth temporary storage structure 124, the third temporary storage structure 134 is separated from the fourth temporary storage structure 124 by concrete, and an interior of the third temporary storage structure 134 is treated with an anti-corrosion measure.

Optionally, there is one third filler 132; or, there are a plurality of third fillers 132, and the plurality of third fillers 132 are disposed at intervals along a length direction of the gas absorption system.

Optionally, there is one fourth filler 121; or, there are a plurality of fourth fillers 121, and the plurality of fourth fillers 121 are disposed at intervals along a length direction of the gas absorption system.

Optionally, a spray density of the first spray structure 31 ranges from 0 m³/m²*h to 20 m³/m²*h, and deionized water is used.

From the above description, it can be seen that the above embodiments of the present disclosure achieve the following technical effects.

The alkaline solution is sprayed through the first spray structure, so that the alkaline solution flowing out through the first spray structure chemically reacts with the carbon dioxide gas in the gas to absorb the carbon dioxide gas. During the above processes, the solution, obtained after the alkaline solution chemically reacts with the carbon dioxide gas, is temporarily stored in the first temporary storage structure, and the solution stored temporarily in the first temporary storage structure flows out again through the first spray structure, so as to achieve recycling of the solution. During a process of capturing carbon dioxide gas, the at least one of the concentration of the hydroxide and the concentration of the carbonate of the solution in the first temporary storage structure is detected in real time, and one of the alkaline solution and the water is supplemented into the first temporary storage structure according to the at least one of the concentration of the hydroxide and the concentration of the carbonate. The concentration of the hydroxide and the concentration of the carbonate of the solution in a final state are precisely controlled by means of alkaline solution supplement or water addition, so as to meet requirements of a process of a subsequent electrolysis, thereby reducing energy consumption of an overall system, and further solving problems in that capture efficiency of carbon dioxide gas and overall energy consumption of a system for capturing carbon dioxide are relatively difficult to control in the related technologies, and thus improving capture efficiency of a system for capturing carbon dioxide. During the process of detecting the at least one of the concentration of the hydroxide and the concentration of the carbonate of the solution in the first temporary storage structure in real time, in the case that the concentration of the hydroxide is detected to be less than or equal to m and the concentration of the carbonate is detected to be n, the first pump body or the third pump body is controlled to stop running, so that the solution stored temporarily in the first temporary storage structure enters the electrolysis device for the electrolysis.

It should be noted that the terms used herein are only for the purpose of describing specific embodiments and are not intended to limit the exemplary embodiments according to the present disclosure. As used herein, unless otherwise explicitly stated in the context, the singular forms are also intended to include the plural forms. In addition, it should also be understood that, when the terms “contain” and/or “include” are used in this specification, it means that there are a feature, a step, an operation, a device, a component, and/or the combinations thereof.

It should be noted that the terms “first”, “second”, etc. in the specification and claims of the present disclosure, as well as in the accompanying drawings, are used to distinguish similar objects and do not necessarily used to describe a specific order or sequence. It should be understood that the data used in this way may be interchanged in appropriate circumstances, so that the embodiments of the present disclosure described herein can be implemented in an order other than those illustrated or described herein.

The above are only preferred embodiments of the present disclosure and are not intended to limit the present disclosure. For a person skilled in the art, there are various modifications and changes in the present disclosure. Any modification, equivalent replacement, improvement, and the like made within the spirit and principle of the present disclosure shall be included within the protection scope of the present disclosure.

What is claimed is:

1. A method for capturing carbon dioxide, comprising:
spraying an alkaline solution through a first spray structure, so that the alkaline solution flowing out through the first spray structure chemically reacts with carbon dioxide gas in gas to absorb the carbon dioxide gas;
temporarily storing a solution, obtained after the alkaline solution chemically reacts with the carbon dioxide gas, in a first temporary storage structure, and making the solution stored temporarily in the first temporary storage structure flow out through the first spray structure;
detecting at least one of a concentration of hydroxide and a concentration of carbonate of the solution in the first temporary storage structure in real time, and supplementing one of an alkaline solution and water into the first temporary storage structure according to the at least one of the concentration of the hydroxide and the concentration of the carbonate; and
during a process of detecting the at least one of the concentration of the hydroxide and the concentration of the carbonate of the solution in the first temporary storage structure in real time, in a case that the concentration of the hydroxide is detected to be less than or equal to m and the concentration of the carbonate is detected to be n, controlling a first pump body or a third pump body to stop running, so that the solution stored temporarily in the first temporary storage structure enters an electrolysis device for an electrolysis.

2. The method for capturing the carbon dioxide according to claim 1, wherein a method for making the solution stored temporarily in the first temporary storage structure flow out through the first spray structure comprises:
starting the first pump body or the third pump body, to pump the solution stored temporarily in the first temporary storage structure into the first spray structure via a pipeline through the first pump body or the third pump body.

3. The method for capturing the carbon dioxide according to claim 1, wherein a method for supplementing one of an alkaline solution and water into the first temporary storage structure according to the at least one of the concentration of the hydroxide and the concentration of the carbonate comprises:
in a case that the concentration of the hydroxide is detected to be less than m and the concentration of the carbonate is detected to be less than n, supplementing the alkaline solution into the first temporary storage structure; and
in a case that the concentration of the hydroxide is detected to be less than or equal to m and the concentration of the carbonate is detected to be greater than n, supplementing the water into the first temporary storage structure.

4. The method for capturing the carbon dioxide according to claim 1, wherein a method for detecting a concentration of hydroxide of the solution in the first temporary storage structure in real time comprises:
feeding the solution into a potentiometric titrator, dripping a standard acid with calibrated H+ concentration into the solution, and during a process of titration, continuously stirring the solution added with the standard acid and recording a first-order differential curve of solution potential with respect to a volume of the standard acid added into the solution, until the first-order differential curve of the solution potential reaches a first peak value, and calculating the concentration of the hydroxide of the solution by using the volume of the standard acid consumed at this time.

5. The method for capturing the carbon dioxide according to claim 1, wherein a method for detecting a concentration of carbonate of the solution in the first temporary storage structure in real time comprises:
feeding the solution into a potentiometric titrator, dripping a standard acid with calibrated H+ concentration into the solution, and during a process of titration, continuously stirring the solution added with the standard acid and recording a first-order differential curve of solution potential with respect to a volume of the standard acid added into the solution, until the first-order differential curve of the solution potential reaches a first peak value, recording the volume of the standard acid consumed at this time as V1; continuing to drip the standard acid with the calibrated H+ concentration into the solution, and during a process of the titration, continuing to stir the solution added with the standard acid and recording a first-order differential curve of solution potential with respect to a volume of the standard acid added into the solution, until the first-order differential curve of the solution potential reaches a second peak value, recording the volume of the standard acid consumed at this time as V2; and calculating the concentration of the carbonate of the solution by using a difference between V2 and V1.

6. The method for capturing the carbon dioxide according to claim 1, wherein a value of m is greater than or equal to 0.1 mol/L and less than or equal to 5 mol/L; and/or a value of n is greater than or equal to 1 mol/L and less than or equal to 6 mol/L.

7. The method for capturing the carbon dioxide according to claim 1, wherein during a process where the solution stored temporarily in the first temporary storage structure enters the electrolysis device for the electrolysis, the method for capturing the carbon dioxide further comprises:
regulating electric charge applied to the electrolysis device, to control a molar yield ratio of carbon dioxide gas to hydrogen in the electrolysis device over unit time and/or a yield of carbon dioxide gas and hydrogen in the electrolysis device over unit time.

8. The method for capturing the carbon dioxide according to claim 7, wherein a method for regulating electric charge applied to the electrolysis device comprises:
obtaining a preset value Q of the electric charge applied to the electrolysis device in a case that the molar yield ratio of the carbon dioxide gas to the hydrogen is 1, and increasing nQ on a basis of the preset value Q of the electric charge, to adjust the molar yield ratio of the carbon dioxide gas to the hydrogen, where n is equal to 1, 2, 3, . . . , N(N≤n).

9. The method for capturing the carbon dioxide according to claim 8, wherein during a process for regulating a molar yield ratio of carbon dioxide gas to hydrogen, the method for capturing the carbon dioxide further comprises:
detecting a content of an electrolyte in the electrolysis device in real time, and in a case that the content of the electrolyte is less than a preset value, adding an electrolyte to the electrolysis device; and the electrolyte is one of alkali metal sulfate, alkali metal nitrate and alkali metal phosphate.

10. The method for capturing the carbon dioxide according to claim 1, wherein a method for temporarily storing a solution, obtained after the alkaline solution chemically reacts with the carbon dioxide gas, in a first temporary storage structure comprises:
providing at least two first temporary storage structures for switching operation, and selectively and temporarily storing the solution, obtained after the alkaline solution chemically reacts with the carbon dioxide gas, in each of the at least two first temporary storage structures; and in a case that a concentration of carbonate in one first temporary storage structure reaches a preset concentration value, deactivating the one temporary storage structure, and enabling a remaining temporary storage structure.

11. A gas absorption system, comprising:
a housing provided with an intake port and an exhaust port, the intake port being in communication with the exhaust port, wherein the exhaust port is located above the intake port; or in a horizontal direction, the intake port and the exhaust port are disposed opposite to each other;
a gas pretreatment device disposed inside the housing and located at the intake port for filtering impurities in gas entering the intake port; and
a gas absorption assembly disposed inside the housing and located downstream of the gas pretreatment device, the gas absorption assembly comprising a first liquid supply device and a first spray structure, the first liquid supply device being in communication with the first spray structure to provide an alkaline solution, and the alkaline solution flowing out through the first spray structure chemically reacting with carbon dioxide gas in the gas to absorb the carbon dioxide gas.

12. The gas absorption system according to claim 11, wherein the gas absorption assembly further comprises:
a first filler disposed opposite to the exhaust port, the first filler being located below the first spray structure;
a first water collector located above the first spray structure;
a first temporary storage structure located below the first filler for temporarily storing a solution obtained after the alkaline solution chemically reacts with the carbon dioxide gas;
a first pipeline, an end of the first pipeline being in communication with the first temporary storage structure, and another end of the first pipeline being in communication with the first spray structure;
a first pump body disposed on the first pipeline for pumping the solution entering the first temporary storage structure into the first spray structure;
a gas delivery device disposed at at least one of the exhaust port and the intake port;
a first detection device disposed inside the first temporary storage structure for detecting a concentration of carbonate of a solution; wherein in a case that a detection value of the first detection device reaches a first preset concentration value, the gas delivery device is controlled to stop running; and
a second detection device disposed inside the first temporary storage structure for detecting a concentration of hydroxide of a solution; wherein in a case that a detection value of the second detection device is less than a second preset concentration value, the first pump body is controlled to start.

13. The gas absorption system according to claim 11, wherein the gas pretreatment device comprises:
a second filler disposed opposite to the intake port;
a second liquid supply device;
a second spray structure located above the second filler, the second liquid supply device being in communication with the second spray structure;
a second water collector disposed opposite to the second filler, wherein there is one second water collector; or there are a plurality of second water collectors, at least one of the plurality of second water collectors is located at a first side of the second filler, and at least one another of the plurality of second water collectors is located at a second side of the second filler;
a second temporary storage structure located below the second filler for temporarily storing liquid flowing out through the second filler;
a second pipeline, an end of the second pipeline being in communication with the second spray structure, and another end of the second pipeline being in communication with the second temporary storage structure; and
a second pump body disposed on the second pipeline for pumping the liquid entering the second temporary storage structure into the second spray structure.

14. The gas absorption system according to claim 13, wherein the second temporary storage structure comprises:
a first temporary storage body;
a first baffle plate disposed inside the first temporary storage body for dividing an inner cavity of the first temporary storage body into a first sub-accommodating cavity and a second sub-accommodating cavity, the first sub-accommodating chamber being located below the second filler, and the second sub-accommodating cavity being in communication with the second pipeline, wherein the first baffle plate is provided with an overflow hole, and the first sub-accommodating cavity is in communication with the second sub-accommodating cavity through the overflow hole; or an overflow portion is disposed between the first baffle plate and the first temporary storage body, and the first sub-accommodating cavity is in communication with the second sub-accommodating cavity through the overflow portion; and
the second filler comprises a plurality of first sub-filler sheets, adjacent two first sub-filler sheets are disposed in a staggered manner and form a flow passage, a surface of each of the plurality of first sub-filler sheets is provided with an interference flow convex portion or an interference flow concave portion located in the flow passage.

15. The gas absorption system according to claim 11, wherein the housing is provided with an accommodating cavity, the intake port is in communication with the exhaust port through the accommodating cavity, and the gas absorption assembly is located inside the accommodation cavity, wherein there is one intake port, and there is one gas pretreatment device; or there are a plurality of intake ports, the plurality of intake ports are disposed around the accommodating cavity, there are a plurality of gas pretreatment devices, and the plurality of gas pretreatment devices and the plurality of intake ports are in a one-to-one correspondence.

16. The gas absorption system according to claim 11, wherein the gas absorption assembly comprises:
a third filler located below the first spray structure;
a third water collector disposed opposite to the third filler, wherein the third water collector is located between the exhaust port and the third filler; and/or the third water collector is located between the third filler and the gas pretreatment device; and
a third temporary storage structure located below the third filler for temporarily storing a solution obtained after the alkaline solution chemically reacts with the carbon dioxide gas, wherein there is one third temporary storage structure; or there are a plurality of third temporary storage structures, and the plurality of third temporary storage structures are selectively put into use.

17. The gas absorption system according to claim 16, wherein there are a plurality of third temporary storage structures, and the gas absorption assembly further comprises:
a second main pipeline, a first end of the second main pipeline being in communication with the first spray structure;
a plurality of third branch pipelines, the plurality of third branch pipelines and the plurality of third temporary storage structures being in a one-to-one correspondence, an end of each of the plurality of third branch pipelines being in communication with respective third temporary storage structures, and another end of each of the plurality of third branch pipelines being in communication with a second end of the second main pipeline;
a plurality of second control valves, the plurality of second control valves and the plurality of third branch pipelines being in a one-to-one correspondence, and each of the plurality of second control valves being configured to control an on-off state of respective third branch pipelines; and at any time, at least one of the plurality of second control valves is in an open state;
a third detection device disposed on the second main pipeline for detecting a concentration of carbonate of a solution in the second main pipeline; wherein in a case that a detection value of the third detection device reaches a preset concentration value, a third branch pipeline corresponding to a third temporary storage structure that has been put into use is controlled to be in a disconnected state by at least one second control valve, and at least one another third temporary storage structure is controlled to put into use by at least one another second control valve; and
a third pump body disposed on one of the second main pipeline and the third branch pipeline for pumping the solution entering the third temporary storage structure into the first spray structure.

18. The gas absorption system according to claim 11, wherein the gas pretreatment device comprises:
a fourth filler disposed opposite to the intake port;
a third liquid supply device;
a third spray structure located above the fourth filler, the third liquid supply device being in communication with the third spray structure; and
a fourth water collector disposed opposite to the fourth filler, wherein there is one fourth water collector; or there are a plurality of fourth water collectors, at least one of the plurality of fourth water collectors is located at a first side of the fourth filler, and at least one another of the plurality of fourth water collectors is located at a second side of the fourth filler;
a fourth temporary storage structure located below the fourth filler for temporarily storing liquid flowing out through the fourth filler;
a third main pipeline, an end of the third main pipeline being in communication with the third spray structure, and another end of the third main pipeline being in communication with the fourth temporary storage structure; and
a fourth pump body disposed on the third main pipeline for pumping the liquid entering the fourth temporary storage structure into the third spray structure.

19. The gas absorption system according to claim 18, wherein the four temporary storage structure comprises:
a second temporary storage body;
a second baffle plate disposed inside the second temporary storage body to divide an inner cavity of the second temporary storage body into a third sub-accommodating cavity and a fourth sub-accommodating cavity, the third sub-accommodating cavity being located below the fourth filler, and the fourth sub-accommodating cavity being in communication with the third main pipeline, wherein the second baffle plate is provided with an overflow hole, and the third sub-accommodating cavity is in communication with the fourth sub-accommodating cavity through the overflow hole; or an overflow portion is disposed between the second baffle plate and the second temporary storage body, and the third sub-accommodating cavity is in communication with the fourth sub-accommodating cavity through the overflow portion; and
the fourth filler comprises a plurality of second sub-filler sheets, adjacent two second sub-filler sheets are disposed in a staggered manner and form a flow passage, a surface of each of the plurality of second sub-filler sheets is provided with an interference flow convex portion or an interference flow concave portion located in the flow passage.

20. The gas absorption system according to claim 12, wherein the gas absorption system further comprises an electrolysis device, the electrolysis device is located downstream of the first temporary storage structure, and a carbonic acid solution discharged through the first temporary storage structure is electrolyzed by the electrolysis device, so that potassium hydroxide and hydrogen are generated at a cathode of the electrolysis device, and gas obtained by mixing oxygen and carbon dioxide is generated at an anode of the electrolysis device; and the potassium hydroxide is used for absorbing carbon dioxide of the gas absorption system.
